(19) United States
(12) Patent Application Publication
(10) Pub. No.: US 2024/0300180 A1
(43) Pub. Date: Sep. 12, 2024

(54) METHODS FOR ERROR CORRECTION DURING ADDITIVE MANUFACTURING

(71) Applicant: Align Technology, Inc., San Jose, CA (US)

(72) Inventors: Viswanath Meenakshisundaram, Santa Clara, CA (US); Nilesh Joshi, Cary, NC (US)

(21) Appl. No.: 18/600,268

(22) Filed: Mar. 8, 2024

Related U.S. Application Data
(60) Provisional application No. 63/489,588, filed on Mar. 10, 2023.
(60) Provisional application No. 63/496,075, filed on Apr. 14, 2023.

(51) Int. Cl. B29C 64/386; B29C 64/171; B33Y 50/00; B29C 64/124

(52) U.S. Cl. CPC B29C 64/386; B29C 64/171; B33Y 50/00; B29C 64/124

(57) ABSTRACT

Systems and methods for manufacturing objects are provided herein. In some embodiments, a method includes: receiving a digital representation of a plurality of objects; forming a first portion of each object of the plurality of objects based on the digital representation, using an additive manufacturing process; obtaining sensor data of the first portion of each object; determining whether an error is present in the first portion of an object of the plurality of objects, based on the sensor data; in response to a determination that the error is present in the first portion of the object, modifying the digital representation to remove the object having the error; and forming a second portion of each remaining object of the plurality of objects based on the modified digital representation, using the additive manufacturing process.

### CROSS-REFERENCE TO RELATED APPLICATION(S)

The present application claims the benefit of priority to U.S. Provisional Application No. 63/489,588, filed on Mar. 10, 2023, and U.S. Provisional Application No. 63/496,075, filed on Apr. 14, 2023, the disclosures of which are incorporated by reference herein in their entirety.

### TECHNICAL FIELD

The present technology generally relates to manufacturing, and in particular, to additive manufacturing systems with error correction and associated methods.

### BACKGROUND

Additive manufacturing encompasses a variety of technologies that involve building up 3D objects from multiple layers of material. However, conventional additive manufacturing systems and devices may be prone to issues that compromise the efficiency, quality, and scalability of the printing process. For example, printing errors may occur if material is deposited at an incorrect location, such as due to timing issues, migration of the material after deposition, or poor adhesion of the deposited material. The occurrence of printing errors can detrimentally affect the dimensional accuracy of the printed object or even cause print failure, thus wasting material and prolonging manufacturing time. Conventional additive manufacturing systems and devices lack the capability to detect and correct such errors and may therefore be unsuitable for large-scale production of printed objects.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1A is a schematic diagram providing a general overview of a system for additive manufacturing, in accordance with embodiments of the present technology.

FIG. 1B is a schematic diagram providing a general overview of a system for additive manufacturing, in accordance with embodiments of the present technology.

FIG. 1C is a schematic diagram providing a general overview of a system for additive manufacturing, in accordance with embodiments of the present technology.

FIG. 2 is a partially schematic diagram providing a general overview of an additive manufacturing process, in accordance with embodiments of the present technology.

FIG. 3A is a partially schematic side view of a system for additive manufacturing configured in accordance with embodiments of the present technology.

FIG. 3B is a partially schematic side view of the system of FIG. 3A during a first stage of operation, in accordance with embodiments of the present technology.

FIG. 3C is a partially schematic side view of the system of FIG. 3A during a second stage of operation, in accordance with embodiments of the present technology.

FIG. 4A is a flow diagram illustrating a method for manufacturing an object, in accordance with embodiments of the present technology.

FIG. 4B is a flow diagram illustrating a method for manufacturing an object, in accordance with embodiments of the present technology.

FIGS. 5A and 5B are partially schematic diagrams providing a general overview of a hybrid additive manufacturing process, in accordance with embodiments of the present technology.

FIG. 6A is a partially schematic side view of a system for additive manufacturing configured in accordance with embodiments of the present technology.

FIG. 6B is a partially schematic side view of the system of FIG. 6A during a first stage of operation, in accordance with embodiments of the present technology.

FIG. 6C is a partially schematic side view of the system of FIG. 6A during a second stage of operation, in accordance with embodiments of the present technology.

FIG. 6D is a partially schematic side view of the system of FIG. 6A during a third stage of operation, in accordance with embodiments of the present technology.

FIG. 6E is a partially schematic side view of the system of FIG. 6A during a fourth stage of operation, in accordance with embodiments of the present technology.

FIG. 7A is a flow diagram illustrating a method for manufacturing an object, in accordance with embodiments of the present technology.

FIG. 7B is a flow diagram illustrating a method for manufacturing an object, in accordance with embodiments of the present technology.

FIG. 8A is a flow diagram illustrating a method for manufacturing a plurality of objects, in accordance with embodiments of the present technology.

FIG. 8B is a flow diagram illustrating a method for manufacturing a plurality of objects, in accordance with embodiments of the present technology.

FIG. 9A is a partially schematic illustration of a digital representation for use in manufacturing a portion of each of a plurality of objects, in accordance with embodiments of the present technology.

FIG. 9B illustrates the digital representation of FIG. 9A after modification, in accordance with embodiments of the present technology.

FIG. 10A illustrates a representative example of a tooth repositioning appliance configured in accordance with embodiments of the present technology.

FIG. 10B illustrates a tooth repositioning system including a plurality of appliances, in accordance with embodiments of the present technology.

FIG. 10C illustrates a method of orthodontic treatment using a plurality of appliances, in accordance with embodiments of the present technology.

FIG. 11 illustrates a method for designing an orthodontic appliance, in accordance with embodiments of the present technology.

FIG. 12 illustrates a method for digitally planning an orthodontic treatment and/or design or fabrication of an appliance, in accordance with embodiments of the present technology.

FIG. 13 is a partially schematic diagram of elements of a process for correcting print errors in additive manufacturing system(s), in accordance with embodiments of the present technology.

### DETAILED DESCRIPTION

As noted herein, errors in manufacturing systems, such as additive manufacturing systems, can significantly hinder performance. It is desirable to be able to detect and/or accommodate errors that could occur in additive manufacturing systems without human intervention. As examples, the ability to detect and/or accommodate issues such as incorrectly deposited material, delamination, deformation, etc., can greatly increase print efficiencies of individual additively manufactured parts and/or groups of additively manufactured parts that are printed as one or more batches. A single error in one part could ruin an entire batch and require the entire batch to be reprinted. Detecting and/or accommodating errors that could occur in additive manufacturing systems could reduce part waste and could help with accelerated process and design development/refinement. Naturally, advantages from detecting and/or accommodating errors that could occur in additive manufacturing systems are further magnified in additive manufacturing systems used for mass customization or volume printing. Detecting and/or accommodating errors that could occur in additive manufacturing systems could prove useful in systems that use two or more 3D printing systems (e.g., systems that use digital light processing (DLP) and material jetting).

The present technology relates to systems for additive manufacturing of objects and associated devices and methods. In some embodiments, for example, a system for manufacturing objects includes a printer assembly configured to perform an additive manufacturing process with a curable material, an imaging device, and a material removal device. The system can also include a processor and a memory storing instructions that, when executed by the processor, cause the system to perform operations to detect and/or correct errors that may occur during an additive manufacturing process. In some embodiments, operations include forming an object portion from the curable material using the printer assembly, generating image data of the object portion using the imaging device, and based on image data, determining whether error(s) are present in the object portion, such as incorrect placement of material in the object portion. In response to a determination that an error is present in the object portion, the material removal device can be used to remove a region of the object portion containing the error (e.g., via removal techniques such as suction, electrostatic interactions, ablation, etc.).

As another example, a method for manufacturing objects can include receiving a digital representation of a plurality of objects, such as objects that are part of a single layout and are intended to be fabricated concurrently in the same manufacturing operation. The method can include forming a first portion of each object of the plurality of objects based on the digital representation, using an additive manufacturing process. Subsequently, image data of the first portion of each object can be obtained using an imaging device. The image data can be used to determine whether any errors are present in the first portion of any of the objects (e.g., incorrectly deposited material, delamination, deformation). In response to a determination that an error is present in the first portion of an object, the digital representation can be modified, e.g., to remove the portions of a digital representation of the object having the error, such as by masking or deleting the pixels corresponding to the object in a digital representation of the object. Based on a modified digital representation, a second portion of each of the remaining objects can be formed via the additive manufacturing process. In some embodiments, some or all of the error detection and/or accommodation functionalities described herein are performed locally relative to print systems. As an example of local performance of functionalities, some or all of the error detection and/or accommodation functionalities described herein could physically reside on a system that also performs additive manufacturing. In some embodiments, some or all of the error detection and/or accommodation functionalities are performed remotely relative to print systems. As an example of remote performance of functionalities, some or all of the error detection and/or accommodation functionalities described herein could physically reside away from a system that also performs additive manufacturing; coupling could be through physical, wireless, and/or other networks, and/or computer-readable media, examples of which are described herein.

The present technology can provide numerous advantages over conventional additive manufacturing techniques. For example, the systems herein can automatically detect and correct errors that occur during fabrication of additively manufactured objects, without requiring monitoring and intervention from a human operator. The systems herein also allow for dynamic and adaptive modifications to the object geometry and/or curing parameters during the additive manufacturing process to correct any errors that occur. In situations where the error cannot be corrected, the systems herein can selectively terminate printing of the affected object, while continuing to fabricate the other objects in the same layout. Accordingly, the embodiments herein can improve the efficiency and accuracy of large-scale additive manufacturing, while reducing time and materials lost due to printing errors.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Systems and Methods for Additive Manufacturing

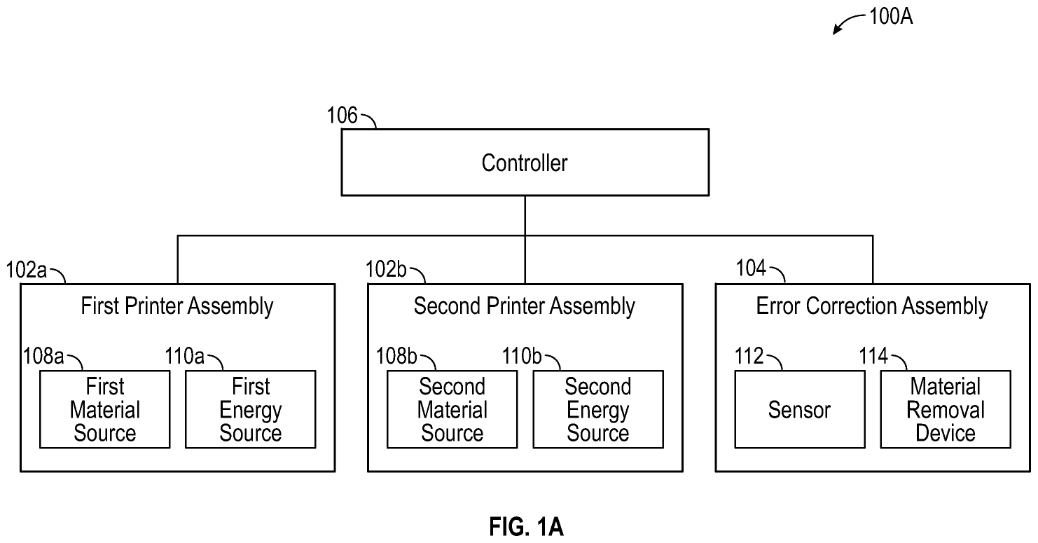

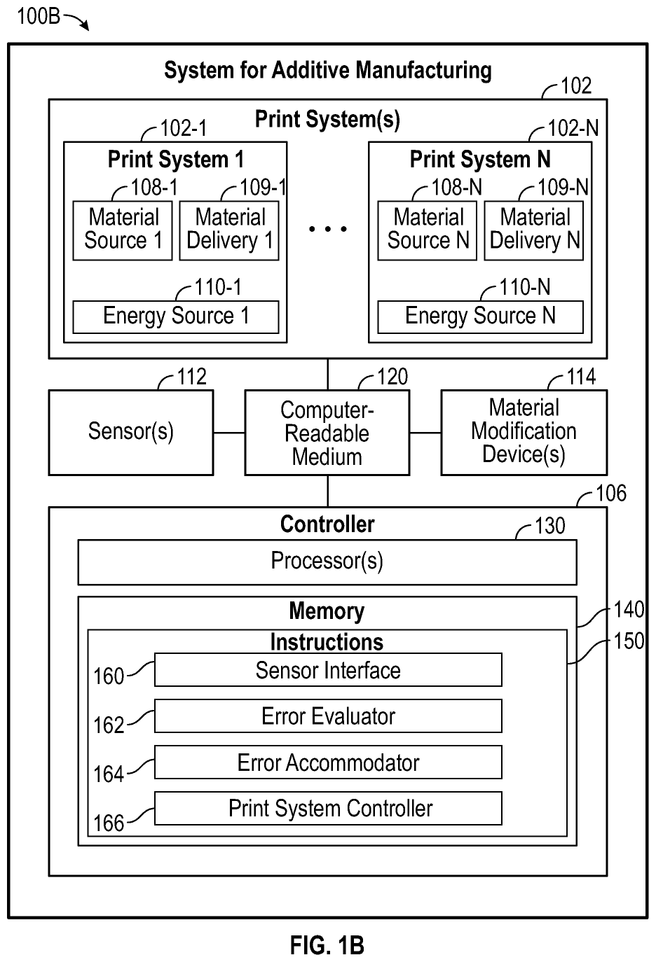

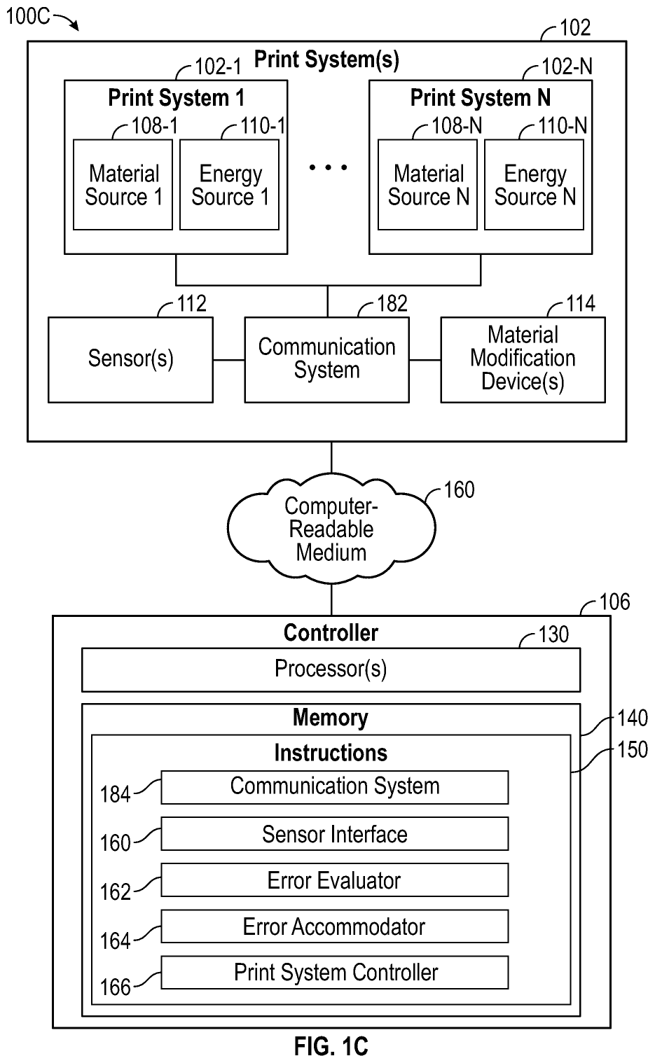

FIGS. 1A-IC are schematic diagrams providing a general overview of a system 100 (shown in FIG. 1A as system 100A, shown in FIG. 1B as system 100B, and shown in FIG. 1C as system 100C) for additive manufacturing, in accordance with embodiments of the present technology. Additive manufacturing (also referred to herein as “3D printing”) includes a variety of technologies which fabricate 3D objects directly from digital models through an additive process. For example, additive manufacturing can be used to directly fabricate orthodontic appliances (e.g., aligners, palatal expanders, retainers, attachment placement devices, attachments), restorative objects (e.g., crowns, veneers, implants), and/or other dental appliances (e.g., oral sleep apnea appliances, mouth guards). Additional examples of dental appliances and associated methods that are applicable to the present technology are described in Section II below.

The system 100A includes at least one printer assembly for fabricating one or more objects via an additive manufacturing technique. Examples of additive manufacturing techniques that may be implemented by the printer assembly or assemblies of the system 100A include, but are not limited to, the following: (1) vat photopolymerization, in which an object is constructed from a vat or other bulk source of liquid photopolymer resin, including techniques such as stercolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. In some embodiments, the object geometry can be built up in a layer-by-layer fashion, with successive layers being formed in discrete build steps. Alternatively or in combination, the object geometry can be built up in a continuous fashion without discrete layers. Optionally, an additive manufacturing process can use a combination of two or more additive manufacturing techniques.

For example, the additively manufactured object can be fabricated using vat photopolymerization process in which light is used to selectively cure a vat or other bulk source of a curable material (e.g., a polymeric resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the material source, light source, and build platform.

As another example, the additively manufactured object can be fabricated using high temperature lithography (also known as “hot lithography”). High temperature lithography can include any photopolymerization process that involves heating a photopolymerizable material (e.g., a polymeric resin). For example, high temperature lithography can involve heating the material to a temperature of at least 30° C., 40° C., 50° C., 60° C., 70° C., 80° C., 90° C., 100° C., 110° C., or 120° C. In some embodiments, the material is heated to a temperature within a range from 50° C. to 120° C., from 90° C. to 120° C., from 100° C. to 120° C., from 105° C. to 115° C., or from 105° C. to 110° C. The heating can lower the viscosity of the photopolymerizable material before and/or during curing, and/or increase reactivity of the photopolymerizable material. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s, 10 Pa-s, 15 Pa-s, 20 Pa-s, 30 Pa-s, 40 Pa-s, or 50 Pa-s at 20° C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In some embodiments, the additively manufactured object is fabricated using continuous liquid interphase production (also known as “continuous liquid interphase printing”) in which the object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety. In another example, a continuous additive manufacturing method can involve extruding a composite material composed of a curable liquid material surrounding a solid strand. The composite material can be extruded along a continuous three-dimensional path in order to form the object. Such methods are described in U.S. Pat. No. 10,162,264 and U.S. Patent Publication No. 2014/0061974, the disclosures of which are incorporated herein by reference in their entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety.

In a further example, the additively manufactured object can be fabricated using a volumetric additive manufacturing (VAM) process in which an entire object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present technology include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting holographic light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present technology are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

In yet another example, the additively manufactured object can be fabricated using a powder bed fusion process (e.g., selective laser sintering) involving using a laser beam to selectively fuse a layer of powdered material according to a desired cross-sectional shape in order to build up the object geometry. As another example, the additively manufactured object can be fabricated using a material extrusion process (e.g., fused deposition modeling) involving selectively depositing a thin filament of material (e.g., thermoplastic polymer) in a layer-by-layer manner in order to form an object. In yet another example, the additively manufactured object can be fabricated using a material jetting process involving jetting or extruding one or more materials onto a build surface in order to form successive layers of the object geometry.

The additively manufactured object can be made of any suitable material or combination of materials. As discussed above, in some embodiments, the additively manufactured object is made partially or entirely out of a polymeric material, such as a curable polymeric resin. The resin can be composed of one or more monomer components that are initially in a liquid state. The resin can be in the liquid state at room temperature (e.g., 20° C.) or at an elevated temperature (e.g., a temperature within a range from 50° C. to 120° C.). When exposed to energy (e.g., light), the monomer components can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

Optionally, the additively manufactured object can be fabricated from a plurality of different materials (e.g., at least two, three, four, five, or more different materials). The materials can differ from each other with respect to composition, curing conditions (e.g., curing energy wavelength), material properties before curing (e.g., viscosity), material properties after curing (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources in order to fabricate an object from a plurality of different materials. Examples of such methods are described in U.S. Pat. Nos. 6,749,414 and 11,318,667, the disclosures of which are incorporated herein by reference in their entirety. Alternatively or in combination, the additively manufactured object can be formed from multiple materials in a plurality of sequential manufacturing steps. For instance, a first portion of the object can be formed from a first material in accordance with any of the fabrication methods herein, then a second portion of the object can be formed from a second material in accordance with any of the fabrication methods herein, and so on, until the entirety of the object has been formed.

As shown in FIG. 1A, the system 100A can include a first printer assembly 102a configured to form at least a portion of an object using a first additive manufacturing technique. The first printer assembly 102a can include a first material source 108a and a first energy source 110a. The first material source 108a can be configured to deposit a first precursor material (e.g., a curable material such as a photopolymerizable resin) onto a build platform. The first precursor material can be cured, polymerized, melted, sintered, fused, and/or otherwise solidified by the first energy source 110a to form a portion of the object and/or to combine the portion with previously formed portions of the object.

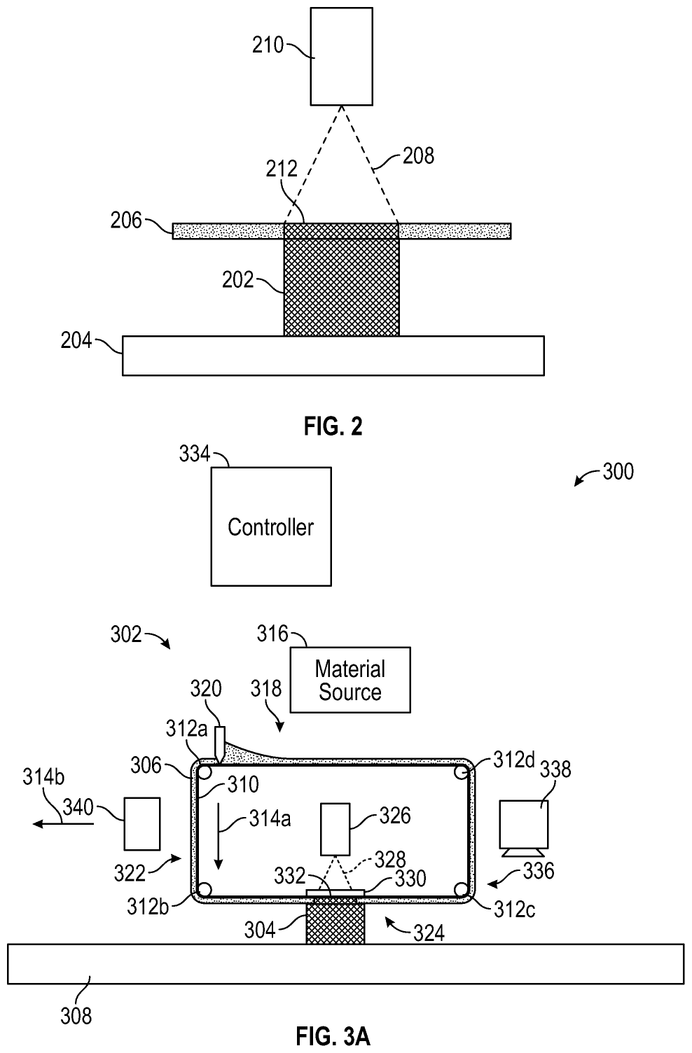

In some embodiments, the system 100A includes a second printer assembly 102b configured to form at least a portion of an object using a second additive manufacturing technique. The second additive manufacturing technique can be the same as the first additive manufacturing technique of the first printer assembly 102a, or can be a different technique. The first and second additive manufacturing techniques can each be independently selected from any of the additive manufacturing techniques described herein. The second printer assembly 102b can include a second material source 108b and a second energy source 110b. The second material source 108b can be configured to deposit a second precursor material (e.g., a curable material such as a photopolymerizable resin) onto a build platform. The second precursor material can be the same as the first precursor material, or can be a different material. The second precursor material can be cured, polymerized, melted, sintered, fused, and/or otherwise solidified by the second energy source 110b to form a portion of the object and/or to combine the portion with previously formed portions of the object. The second energy source 110b can output the same type of energy as the first energy source 110a (e.g., energy having the same wavelength), or can output a different type of energy (e.g., energy having a different wavelength). Representative examples of configurations for the first printer assembly 102a and/or the second printer assembly 102b are described further below in connection with FIGS. 2-6E.

The controller 106 can be operably coupled to the printer assemblies 102a, 102b of the system 100A to control the operation thereof. The controller 106 can be or include a computing device including one or more processors and memory storing instructions for performing the additive manufacturing operations described herein. For example, the controller 106 can receive a digital representation of the target object geometry to be printed, such as a 3D model of the entire object geometry and/or a plurality of 2D images (e.g., bitmap images) representing a plurality of layers for incrementally building up the object geometry (also referred to herein as “slices” of the object). The controller 106 can transmit instructions (e.g., control signals) to each of the printer assemblies 102a, 102b to fabricate the object using the corresponding additive manufacturing process, according to the digital representation. The instructions can control the operation of the material sources 108a, 108b (e.g., amount of material deposited, type of material deposited, deposition location), the energy sources 110a, 110b (e.g., exposure time, exposure pattern, exposure wavelength, energy density, power density), and/or other relevant parameters for additive manufacturing (e.g., material temperature).

In the illustrated embodiment, the system 100A can coordinate the operation of the first printer assembly 102a and the second printer assembly 102b to collectively form the desired object geometry. For example, the digital representation of the target object geometry received by the controller 106 can include a first digital representation (e.g., a first 3D model and/or plurality of first 2D images) corresponding to one or more first object portions to be formed by the first printer assembly 102a, and a second digital representation (e.g., a second 3D model and/or plurality of second 2D images) corresponding to one or more second object portions to be formed by the second printer assembly 102b. The controller 106 can instruct the first printer assembly 102a to form the first object portion(s) from the first precursor material, based on the first digital representation, and can instruct the second printer assembly 102b to form the second object portion(s) from the second precursor material, based on the second digital representation. The first and second object portion(s) can be formed sequentially or concurrently, as desired. Each object portion can have any suitable geometry. For instance, an object portion can be an entire layer of the object, or only part of a layer of the object.

The size and locations of the first and second object portions can be determined based on the desired geometry and properties for the final printed object. Depending on the composition and properties of the first and second precursor materials, the first and second object portions can differ from each other with respect to at least one material property, such as one or more of the following: modulus (e.g., clastic modulus, flexural modulus, storage modulus), glass transition temperature, elongation to break, elongation to yield, strength, solubility, hardness, scratch resistance, roughness, degradability, color, refractive index, energy absorption, energy dissipation, energy reflection, energy scatter, transparency, diffusion, pH, porosity, morphology, chemical composition, molecular recognition, molecular absorption, molecular release, phase separation, morphology, or durability. The different material properties can enhance the functionality of the final printed object. For example, in embodiments where the printed object is a dental appliance, the different material properties can be used to control the magnitude and/or direction of forces applied by the dental appliance to the patient's teeth. Moreover, in embodiments where the object is printed with support structures (e.g., struts, cones, pillars) that connect the object to a build platform, the different material properties can be used to create weakened locations at or near the interface between the support structures and the object, to make it easier to separate the object from the support structures during post-processing.

In some instances, errors may occur while the system 100A is operating to form one or more additively manufactured objects using the first printer assembly 102a and/or the second printer assembly 102b. Errors may occur before energy has been applied to cure the deposited material, after energy has been applied to cure the deposited material, or both. Examples of such errors include, but are not limited to, any of the following: deposition of material at an incorrect location, failing to deposit material at a correct location, deposition of an incorrect amount of material (e.g., too much or too little material), curing of material at an incorrect location, failing to cure material at a correct location, incorrect curing extent (e.g., overcuring, undercuring), and/or changes in the geometry of the material after deposition and/or curing (e.g., due to material migration, warping, or poor interlayer adhesion). For instance, in embodiments using a printer assembly that moves while material deposition is occurring, errors in material deposition can arise if there is a timing mismatch between movement of the printer assembly, material deposition by the printer assembly, and/or the control signals sent to the printer assembly by the controller 106. Material deposition errors can also occur if the printer assembly is not properly aligned with the active print area, if the printer assembly becomes clogged or otherwise fails to properly deposit the material, if the material migrates from the initial placement location after deposition (e.g., duc to surface energy, capillary effect), and/or if there is an unintended offset between the build platform and the printer assembly (e.g., due to forces experienced by the build platform during manufacturing of previous object portions, such as shear forces).

Accordingly, the system 100A can include an error correction assembly 104 configured to detect and correct errors that may occur during additive manufacturing. The error correction assembly 104 can include at least one sensor 112 configured to generate sensor data that can be analyzed to determine whether any errors are present in the printed portion of the object, such as errors in material deposition, curing, and/or any of the other error types described herein.

For example, the sensor 112 can be or include an imaging device (e.g., camera, scanner) configured to generate 2D and/or 3D image data of the printed portion of the object. The imaging device can capture images of the object portion in any suitable wavelength, such as infrared wavelengths, visible wavelengths, ultraviolet wavelengths, or combinations thereof. In some embodiments, the imaging device captures the response of the object portion to certain energy wavelengths (e.g., fluorescence imaging) and/or captures variations in transmission of certain energy wavelengths through the object portion (e.g., x-ray imaging or other radiation-based imaging techniques). Optionally, the precursor material of the first printer assembly 102a and/or the second printer assembly 102b can include components to enhance visualization when imaged by the imaging device, such as dyes (e.g., dyes that are visible in infrared, visible, and/or ultraviolet wavelengths) and/or other components that modify the optical properties of the material (e.g., transparency, absorbance, transmissivity, reflectivity). In some embodiments, multiple imaging devices are used to generate image data of the object portion from multiple viewpoints, and the image data can subsequently be combined to reconstruct the 3D object geometry using techniques such as tomography.

In embodiments where the system 100A includes a first printer assembly 102a and second printer assembly 102b, the first precursor material and the second precursor material can have different optical characteristics such that the different materials can be differentiated from each other in the image data obtained by the imaging device. For instance, the first precursor material can be selectively visible when imaged using a first wavelength of light, and the second precursor material can be selectively visible when imaged using a second, different wavelength of light. Accordingly, image data captured at different wavelengths can be used to determine when an error has occurred in the first precursor material only or in the second precursor material only. As another example, the first precursor material and the second precursor material can both be visible in the image data, but can have different optical characteristics (e.g., color, opacity) that allow the materials to be differentiated from each other.

The controller 106 can receive and process the image data (e.g., using computer vision algorithms and/or machine learning algorithms) to determine the actual geometry of the printed object portion, such as the locations where one or more materials have been deposited, the amount of material deposited at each location, and/or the types of materials deposited at each location. The controller 106 can compare the actual geometry to a target geometry for the object portion, which can be determined from a digital representation of the object (e.g., the 3D model and/or 2D images received by the controller 106). For example, in embodiments where the digital representation of the object includes a plurality of coordinate locations (e.g., pixels or voxels) indicating where material should or should not be deposited, the controller 106 can compare each coordinate location in the digital representation of the target object geometry to a corresponding coordinate location in the image data of the actual object geometry to identify whether any discrepancies are present. Based on the comparison, the controller 106 can detect whether any errors are present in the object portion, such as locations where material was incorrectly deposited (e.g., the actual object geometry includes material at that location but the target object geometry does not) and/or locations where material was incorrectly omitted (e.g., the target object geometry includes material at that location but the actual object geometry does not).

Alternatively or in combination, other types of sensors 112 can be used to determine the presence of errors in the printed object portions. For instance, the system 100A can be configured to characterize the amount of material that has been deposited based on the response of the object portion to mechanical perturbations (e.g., vibrations). The mechanical perturbations can be applied by an agitator including a vibrating element configured to generate vibrations in the object portion, such as a piezoelectric transmitter or an acoustic (e.g., ultrasonic) transmitter. The system 100A can include at least one sensor 112 that obtains sensor data indicative of the response of the object portion to the mechanical perturbations, such as the displacement amplitude and/or displacement frequency of the object over time. For example, the sensor 112 can be a piezoelectric receiver, an acoustic (e.g., ultrasonic) receiver, an imaging device (e.g., a camera), displacement sensor, distance sensor, force sensor, strain sensor, and/or position sensor. The controller 106 can use the measured response of the object portion to the mechanical perturbations to calculate the mass and/or volume (e.g., thickness) of the object portion. For example, one or more acoustic pings can be sent toward one or more particular locations along the object portion, and reflecting pings from the particular locations along the object portion can be used to calculate a thickness of the object portion at the particular locations. This can be based on, for example, frequency characteristics of the reflecting pings (which can vary based on the distance of the path of the reflecting pings through the object portion). The calculated mass/volume can be compared to a target mass/volume for the object portion (e.g., the predicted mass/volume of the object portion if material was correctly deposited). Discrepancies between the calculated mass/volume and the target mass/volume can be indicative of errors in the object portion. For instance, if the calculated mass/volume exceeds the target mass/volume, this can indicate that material was incorrectly deposited at one or more locations. Conversely, if the calculated mass/volume is less than the target mass/volume, this can indicate that material was incorrectly omitted at one or more locations.

In some embodiments, the system 100A includes at least one sensor 112 that obtains sensor data representative of an operational state of the first printer assembly 102a and/or the second printer assembly 102b. The operational state can be, for example, a velocity, acceleration, force, torque, etc., of one or more movable components of the first printer assembly 102a and/or the second printer assembly 102b (e.g., a motor driving rotation of a carrier film supporting the material thereon, a motor driving movement of the printer assembly relative to a build platform). Changes in the operational state of the first printer assembly 102a and/or the second printer assembly 120b may be correlated to errors in the printed object portion. For instance, changes in the velocity, acceleration, force, torque, etc., of one or more movable components may indicate that too much or too little material has been deposited, and/or that material has been deposited at an incorrect location, etc. Such changes can be measured by motion sensors (e.g., accelerometers), position sensors, distance sensors, force sensors, strain gauges, and/or suitable combinations thereof.

If the controller 106 makes a determination about the existence and/or absence of an error in the printed object portion, the controller 106 can instruct the error correction assembly 104 to take actions to correct or otherwise mitigate the error. For example, if the error involves material being deposited at an incorrect location, the error correction assembly 104 can use a material removal device 114 to remove the incorrectly deposited material. In some embodiments, the material removal device 114 selectively removes only the regions of the printed object portion containing the error, such as the specific locations where material was incorrectly deposited, while leaving the remaining regions of the object portion intact. This approach can be used in situations where the location of the error can be identified with sufficient accuracy, the error is relatively small, and/or the characteristics of the material (e.g., viscosity, wettability, surface energy) allow the material to be selectively removed from a target location without disturbing material at other locations. In other embodiments, however, the material removal device 114 can remove other regions of the object portion together with the region containing the error. For instance, the material removal device 114 can also remove material from locations adjacent to and/or near the location of the error (e.g., within 1 mm, 2 mm, 3 mm, 4 mm, 5 mm, or 1 cm of the location of the error). In some embodiments, the material removal device 114 can remove the entire object portion containing the error, such as the entirety of the last printed layer of the object. This approach can be used in situations where the exact location of the error is uncertain, if the error is relatively large, and/or the characteristics of the material are not amenable to selective removal.

The material removal device 114 can include any device suitable for removing the precursor material from the object portion. For example, the material removal device 114 can include a vacuum mechanism configured to remove the material by suctioning the material out of the object portion. In embodiments where the material is viscous (e.g., a resin), the vacuum mechanism can optionally be used in combination with another mechanism that reduces the viscosity of the material to facilitate suction, such as an agitator that vibrates the object portion for shear-induced thinning, and/or a heat source that heats the object portion.

As another example, in embodiments where the material is or includes a charged species, the material removal device 114 can be configured to remove the material from the object portion via electrostatic interactions. For instance, the material removal device 114 can include a roller, drum, screen, or other component having a surface that can be charged (e.g., capacitively charged). The charged surface can be brought into proximity with the material (e.g., within a threshold distance of the material) to remove the material from the object portion via electrostatic interactions. Optionally, the surface can be selectively charged (e.g., using a mechanism capable of pixel-level charging such as a laser) to allow for selective removal of the material from one or more targeted locations only.

In a further example, the material removal device 114 can include an ablation mechanism (e.g., a laser or other high energy source) configured to remove the material by ablating (e.g., vaporizing, melting, blasting) the material from the object portion. Other types of removal techniques that can be implemented by the material removal device 114 include, but are not limited to: applying a solvent (e.g., isopropanol) to dissolve and/or wash material out of the object portion; applying a pressurized gas (e.g., an air knife) to flush material off the object portion; heating the object portion to melt material off the object portion; applying mechanical forces (e.g., shaking, brushing, scraping, cutting, cleaving) to physically separate material from the object portion; applying another material that induces a phase change, state change, and/or solubility change to the material of the object portion to facilitate removal; and/or any other physical and/or chemical-based approaches for material removal. Representative examples of configurations for the material removal device 114 are provided below in connection with FIGS. 2-6E.

Once the erroneously deposited material has been removed, the system 100A can continue with additive manufacturing of the object, such as by instructing the first printer assembly 102a and/or the second printer assembly 102b to reprint any regions of the object portion that were removed together with the region containing the error. For example, if an entire layer of the object was removed to correct the error, the system 100A can instruct the first printer assembly 102a and/or second printer assembly 102b to reform that layer before continuing to form the next layer. If the error was corrected by removing only the region of the object portion containing the error, the system 100A can instruct the first printer assembly 102a and/or second printer assembly 102b to continue directly with forming the next layer of the object.

The controller 106 can alternatively or additionally take other actions to correct or otherwise mitigate detected errors. For example, if the error involves omission of material at a desired location, the controller 106 can instruct the appropriate printer assembly to correct the error by depositing material at that location. As another example, if the error involves insufficient curing of material at a particular location, the controller 106 can instruct the appropriate printer assembly to correct the error by applying additional energy at that location to increase the degree of curing. In a further example, if the error involves a misalignment between the build platform and the printer assembly, the controller 106 can apply an adjustment to the appropriate printer assembly and/or to the digital representation of the object used by the printer assembly to compensate for the misalignment. For instance, if the misalignment is caused by the build platform shifting relative to the printer assembly by a relatively small distance (e.g., a few millimeters), the controller 106 can apply a linear transformation to the positioning of the printer assembly and/or to the digital representation of the object, such that the linear transformation compensates for the offset between the build platform and the printer assembly.

In some embodiments, the controller 106 is configured to dynamically adjust the digital representation of the object to compensate for a detected error. The adjustments can include, for example, modifying a geometry of a subsequent portion of the object (e.g., changing size, and/or shape), modifying energy parameters to be used to form a subsequent portion of the object (e.g., changing exposure time, energy intensity, and/or grayscale value), modifying a geometry of another object proximate to the object with the detected error, modifying energy parameters to be used to form another object proximate to the object with the detected error, or suitable combinations thereof. For instance, if it is determined that one layer of the object was not sufficiently cured, an increased energy dosage can be applied to the subsequent layer of the object to cure the previous layer via overcuring. In some embodiments, the controller 106 implements a software algorithm that generates a corrective geometry for the object portion and/or a subsequent object portion, and then instructs the appropriate printer assembly to print the object portions and/or subsequent object portion with the corrective geometry. The appropriate corrective geometry can be determined based on the type of error observed, and can be generated using a simulation, rule-based algorithm, machine learning algorithm, or any other suitable approach.

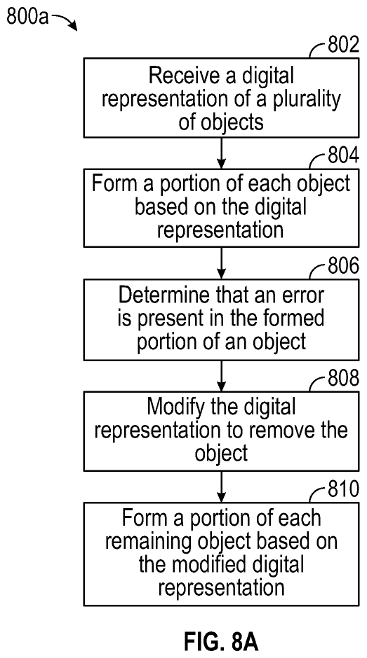

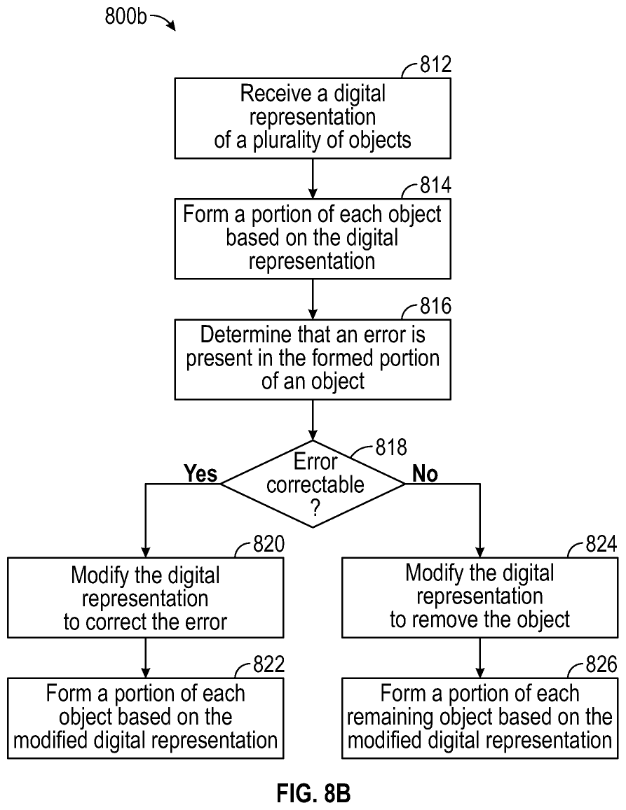

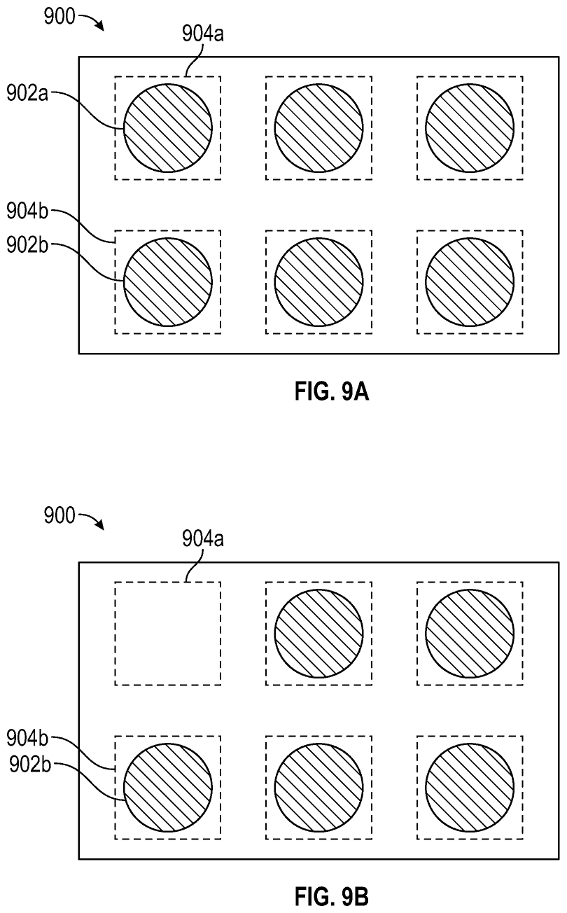

In some embodiments, if the controller 106 determines that the error is too severe to be corrected using the error correction assembly 104, the controller 106 can instruct the first printer assembly 102a and/or second printer assembly 102b to stop printing the object containing the error while continuing to print other objects that do not include errors, as described in greater detail below, e.g., in connection with FIGS. 8A-9B. Moreover, the controller 106 can alternatively or additionally pause the printing operation, terminate the printing operation, and/or generate a notification alerting a human operator about the presence and/or the absence of an error.

The error detection and correction processes described herein can be performed at any suitable stage in the operation of the system 100A. For instance, errors can be detected and/or corrected after depositing a material but before applying energy to cure the material, after depositing the material and after applying the energy to cure the material, or both. The appropriate timing for detecting and correcting errors can vary depending on the type of material, additive manufacturing technique, and/or material removal technique used.

The system 100A shown in FIG. 1A can be modified in many different ways. For example, although FIG. 1A illustrates an embodiment of the system 100A with two printer assemblies 102a, 102b, in other embodiments, the system 100A can include a different number of printer assemblies, such as a single printer assembly (e.g., the first printer assembly 102a only or the second printer assembly 102b only) or three, four, five, or more printer assemblies. In embodiments where the system 100A includes multiple printer assemblies, each printer assembly can independently be configured to implement any suitable additive manufacturing technique. Some or all of the printer assemblies can use the same additive manufacturing technique, or some or all of the printer assemblies can use different additive manufacturing techniques. Additionally, some or all of the printer assemblies can print using the same precursor material, or some or all of the printer assemblies can print using different precursor materials. Optionally, a single printer assembly can include a plurality of material sources for printing using a plurality of different precursor materials (e.g., a material jetting printer having multiple nozzles for depositing different materials). In some embodiments, each printer assembly has its own respective material source and energy source, while in other embodiments, some or all of the printer assemblies may share the material source and/or energy source (e.g., the first energy source 110a can be used to cure both the first precursor material of the first printer assembly 102a and the second precursor material of the second printer assembly 102b). The techniques described herein can be modified to accommodate any suitable number and configuration of printer assemblies.

Additionally, although FIG. 1A illustrates a single error correction assembly 104, in other embodiments, the system 100A can include a plurality of error correction assemblies (e.g., two, three, four, five, or more error correction assemblies). Each error correction assembly can be independently configured to implement any suitable material removal technique. Some or all of the error correction assemblies can use the same material removal technique, or some or all of the error correction assemblies can use different material removal techniques. Optionally, a single error correction assembly can include multiple material removal devices 114 that implement different respective material removal techniques (e.g., suction and washing). The types of material removal techniques used can vary depending on the types of materials used by the system 100A.

FIG. 1B is a schematic diagram providing a general overview of a system 100B for additive manufacturing. In the example of FIG. 1B, the system 100B includes print system(s) 102, controller 106, sensor(s) 112, material modification device(s) 114, and computer-readable medium 120. The elements of the system 100B may be coupled to one another and/or to elements not explicitly shown in FIG. 1B. For instance, print system(s) 102, controller 106, sensor(s) 112, and/or material modification device(s) 114 may be coupled to one another through computer-readable medium 120. One or more of print system(s) 102, controller 106, sensor(s) 112, and/or material modification device(s) 114 may be embedded on a common chip or other hardware.

In the example of FIG. 1B, print system(s) 102 include one or more print systems, shown in FIG. 1B as print system 102-1 through print system 102-N. Print system(s) 102 can include some or all of the elements of print systems 102, shown in FIG. 1A. Print system(s) 102 can include multi-mode print systems. A multi-mode print system, as used herein, can include a print system that supports two or more print modes. Print modes can include machinery, hardware, and/or software to enable print processes. Examples of print modes include vat photopolymerization, material jetting, binder jetting, poly jetting, powder bed fusion, material extrusion, directed energy deposition, and sheet lamination. In some implementations, print system(s) 102 support DLP and ink-jetting modes. For example, print system(s) 102 can include a first print system supporting machinery, hardware, and/or software to enable DLP 3D printing 3D printed items. Print system(s) 102 can further include a second print system supporting machinery, hardware, and/or software to enable ink-jet 3D printing of 3D printed items.

Print system(s) 102 can include material source(s) 108, material delivery system(s) 109, and/or energy source(s) 110. Material source(s) 108 can include machinery and/or hardware to deliver material to print system(s) 102. In some embodiments, material source(s) 108 include storage units (not shown) to hold curable material that is to be 3D printed into a 3D printed item. While shown as distinct, material source(s) 108 can be shared between print system(s) 102. Material delivery system(s) 109 can deliver curable material to build regions (e.g., build plates) on which a 3D printed part is to be formed. As examples, material delivery system(s) 109 can include carrier film(s), nozzle(s), etc., that allow resin to be delivered to a relevant area so that a part can be formed. In an implementation, a first material delivery system 109 includes a carrier film and a second material delivery system 109 includes a material jetting system. Energy source(s) 110 can include machinery and/or hardware to deliver energy to a region of print system(s) 102. In some embodiments, energy source(s) 110 include light sources and/or sources of heat to cause uncured material to be cured. Energy sources 110 can include DLP machinery and/or hardware to cause uncured material to be selectively patterned and/or exposed to light to 3D print 3D printed items. Energy sources 110 need not provide selective patterning and/or exposure; it is noted that in some embodiments, energy sources 110 can non-selectively cure any material exposed to them. While shown as distinct, energy source(s) 110 can be shared between print system(s) 102.

Sensor(s) 112 can include machinery and/or hardware to sense properties and/or states of print system(s) 102. In some embodiments, sensor(s) 112 include one or more of a piezoelectric receiver, an acoustic (e.g., ultrasonic) receiver, an imaging device (e.g., a camera), a displacement sensor, a distance sensor, a force sensor, a strain sensor, a temperature sensor, and/or a position sensor. In some embodiments, the functionalities of sensor(s) 112 can be incorporated into functionalities of controller 106 when analyzing portions of images to be 3D printed into 3D printed items. Material modification device(s) 114 can include machinery and/or hardware to remove material printed in error and/or identified as containing elements of error. In some embodiments, the functionalities of material modification device(s) 114 can be incorporated into functionalities of controller 106 when analyzing portions of images to be 3D printed into 3D printed items; this is noted further herein.

Computer-readable medium 120 can include any transitory or non-transitory computer-readable medium or architecture capable of facilitating communication or data transfer. Examples of computer-readable medium 120 include, without limitation, wires, buses, cabling, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network. In an implementation, computer-readable medium 120 resides on a device with print system(s) 102 and/or controller 106. Computer-readable medium 120 can include any transitory or non-transitory computer-readable medium or architecture to couple print system(s) 102, controller 106, sensor(s) 112, and/or material modification device(s) 114 to one another.

Controller 106 can include a system to provide control to print system(s) 102, sensor(s) 112, material modification device(s) 114, and/or other items. In the example of FIG. 1B, controller 106 includes processor(s) 130 and memory 140. Processor(s) 130 can comprise one or more physical processors. Examples of physical processor(s) include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor. Memory 140 can include physical hardware to store and/or manage data. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

In the example of FIG. 1B, memory can include computer-program instructions 150. Computer-program instructions 150 can implement one or more engines that, when executed by processor(s), cause controller 106 to perform specific actions. When executed by processor(s) 130, for instance, computer-program instructions 150 can cause controller 106 to control machinery and/or hardware on print system(s) 102 (e.g., material source(s) 108, material delivery system(s) 109, energy source(s) 110, etc.).

In the example of FIG. 1B, computer-program instructions 150 include sensor interface 160, error evaluator 162, error accommodator 164, and print system controller 166. Sensor interface 160 can implement instructions to interface with one or more sensors, e.g., sensor(s) 112. Sensor interface 160 can include instructions that gather sensor data about print system(s) 102 from sensor(s) 112. Examples of sensor data include images, piezoelectric data, acoustic data, displacement data, distance data, force data, strain data, temperature data and/or position data related to one or more elements of print system(s) 102. In various examples, sensor interface 112 implements machine and/or assembly code that facilitates gathering sensor data from sensor(s) 112.

Error evaluator 162 can include instructions that, when executed by processor(s) 130, evaluate sensor data for the presence or the absence of print errors. In an example architecture, error evaluator 162 implements a database of potential print errors, and a rules engine to associate sensor data with potential print errors. The rules engine can provide for the presence and/or absence of print errors. As noted herein, print errors can take many different forms. As examples, print errors can be associated with: whether or not too much or too little material was deposited in a given print layer; whether or not a particular material deposition geometry is likely to relate to part warpage, breakage, and/or other failure; whether material source(s) 108, material delivery system(s) 109, and/or energy source(s) 110 are likely to print a layer that will have issues; whether or not material source(s) 108, material delivery system(s) 109, and/or energy source(s) 110 will be in a faulty or error-prone state; etc.

Error accommodator 164 can include instructions that, when executed by processor(s) 130, accommodate print errors. In an example architecture, error accommodator 164 can implement a database of corrective actions, and a rules engine to associate print errors with corrective actions. Examples of corrective actions include modifying material, masking a portion of an image, skipping printing a portion of an image; providing instructions for additional/lesser material and/or additional/lesser cure dosage, etc.

Print system controller 166 instructs physical machinery (e.g., material modification device(s) 114, material source(s) 108, material delivery system(s) 109, energy source(s) 110, etc.) to take action. Print system controller 166 may implement machine and/or assembly code that controls machinery on print system(s) 102 and/or material modification device(s) 114. In some embodiments, print system controller 166 instructs material modification device(s) 114 to add and/or remove material in a second print layer (e.g., subsequent print layer) in response to the presence of print errors in first print layer. In some embodiments, print system controller 166 modifies properties of at least a portion of an image representing a 3D item to be 3D printed. As examples, print system controller 166 can mask at least a portion of an image so that portion does not print; can skip printing a portion and move to the next print layer; can instruct energy source(s) 110 to deliver additional or less energy to a layer than expected in order to compensate for an error; etc.

It is noted that the elements of controller 106 need not include processor(s) 130 and/or memory 140. As an example, in some embodiments, controller 106 can include analog control elements that execute the functionalities described herein. Analog control elements can obtain sensor data related to one or more properties of print system(s) 102, evaluate sensor data for print errors to occur within one or more print layers, accommodate print errors using control, compensation, and/or other techniques, and instruct machinery on print system(s) 102 to take corrective action(s). Print system(s) 102 can correspondingly take corrective action in response to instructions from controller 106.

It is noted that some or all of the elements of FIG. 1B are optional. As an example, some embodiments need not include sensor(s) 112 as physical elements; the functionalities of sensor(s) 112 can be implemented by controller 106 when analyzing portions of images to be 3D printed into 3D printed items. As another example, some embodiments need not include material modification device(s) 114; as noted herein, relevant error accommodation techniques may be implemented by controller 106 when modifying at least portions of images to be 3D printed into 3D printed items. For example, in some embodiments, the functionalities ascribed to sensor(s) 112 and/or material modification device(s) 114 can be incorporated into software executed by controller 106.

In operation, system 100B can operate to evaluate 3D printed items for the presence and/or the absence of print errors and can adaptively compensate for print errors. In some embodiments, material source(s) 108 include curable 3D printable material to a build platform for 3D printing. Reservoirs, vats, and/or supply lines of curable material may be supplied. Material delivery system(s) 109 are instructed to provide specified amounts of curable material to one or more build platforms. As noted herein, a first print mode may include a first material delivery system (e.g., a carrier film) and a second print mode may include a second material delivery system (e.g., a nozzle/extruder as part of a jetting process). In a multi-modal system, build platforms may be distinct or shared across print modalities. Sensor(s) 112 can operate to sense print system(s) 102 and/or items built therein for various physical properties. Sensor(s) 112 can provide sensor data to controller 106, wherein sensor interface 160 can transform sensor data to an appropriate format for error evaluator 162. Error evaluator 162 can evaluate sensor data for the presence or absence of print errors. Error accommodator 164 can identify one or more corrective actions to take based on an evaluation of sensor data for the presence or absence or print errors. Depending on configuration, error accommodator 164 can modify images representing 3D printed items and/or instruct material modification device(s) 114 to take corrective actions.

In the system of FIG. 1C, system 100C includes computer-readable medium 160 that couples print system(s) 102 and controller 106 to one another. The computer-readable medium 160 can include any transitory and/or non-transitory computer-readable medium, examples of which are discussed herein. Print system(s) 102 can include communication system 182. Instructions 150 within memory 140 within controller 106 can include communication system 184. Communication system 182 and/or communication system 184 can include instructions to transform data from a communication format appropriate for respective print system(s) 102 and/or controller 106 into a format that can be transmitted by computer-readable medium 160. In some embodiments, communication system 182 and/or communication system 184 can format sensor data and/or corrective action data into a format suitable for transmission over a network. For example, communication system 182 and/or communication system 184 can format sensor data and/or corrective action data into network packets that can be transferred between print system(s) 102 and/or controller 106. In operation, computer-readable medium 160 can allow controller 106 to remotely control print system(s) 102. Remote control of print system(s) 102, as used herein, can include control of print system(s) 102 from an electronic device that is not shared with print system(s) 102 and/or from a location that is not shared with print system(s) 102. As such, in operation, controller 102 can direct print system(s) 102 to take corrective action over a network and/or using a remote architecture.

Any of the components of the systems 100A, 100B, and/or 100C shown as distinct components in FIGS. 1A-IC can be combined and/or include interrelated code. Any of the components of the systems 100A, 100B, and/or 100C can be implemented as a single and/or interrelated piece of software, or as different pieces of software. Any of the components of the systems 100A, 100B, and/or 100C can be embodied on a single machine or any combination of multiple machines. For example, the first printer assembly 102a and the second printer assembly 102b can be combined with each other and/or with other components such as the error correction assembly 104 and/or the controller 106. Optionally, the controller 106 can include the error correction assembly 104. Further, it is noted that the systems 100A, 100B, and 100C are shown in distinct diagrams for illustrative purposes only, and that some or all of the elements of system 100A may reside in system 100B and/or system 100C, some or all of the elements of system 100B may reside in system 100A and/or system 100C, and some or all of the elements of system 100C may reside in system 100A and/or system 100B.

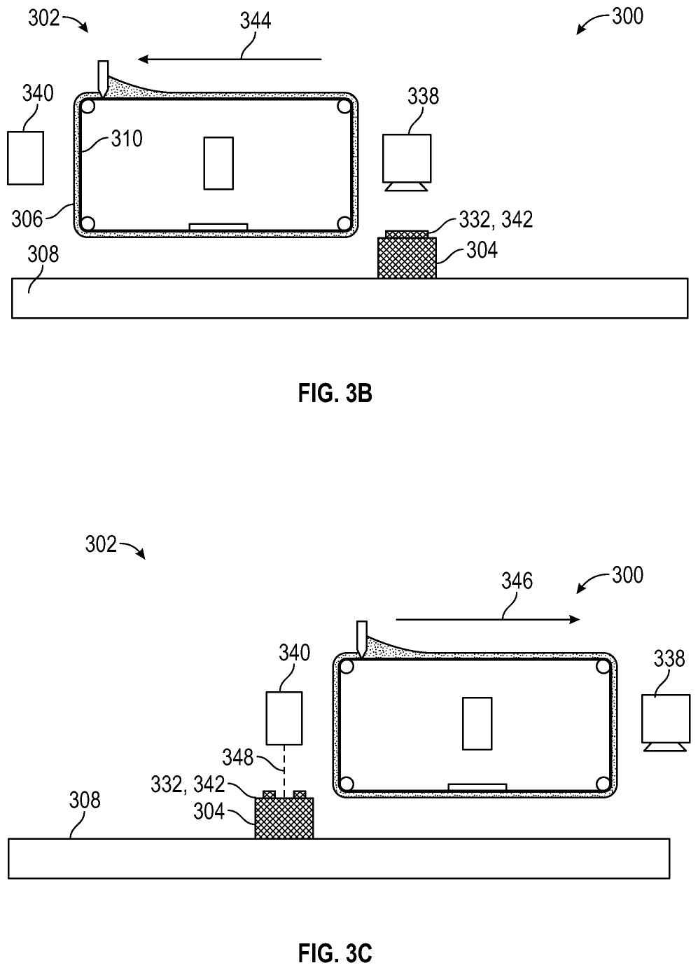

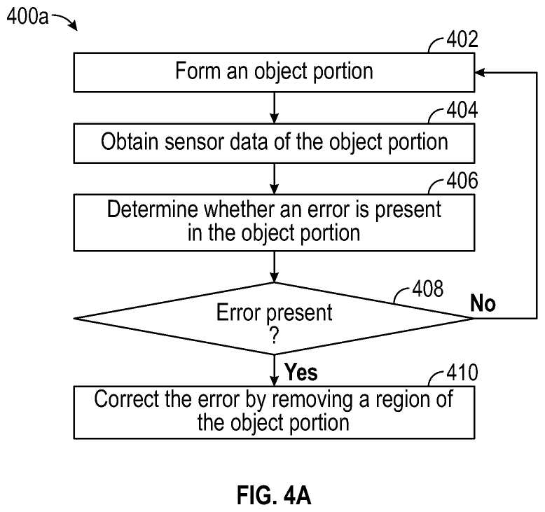

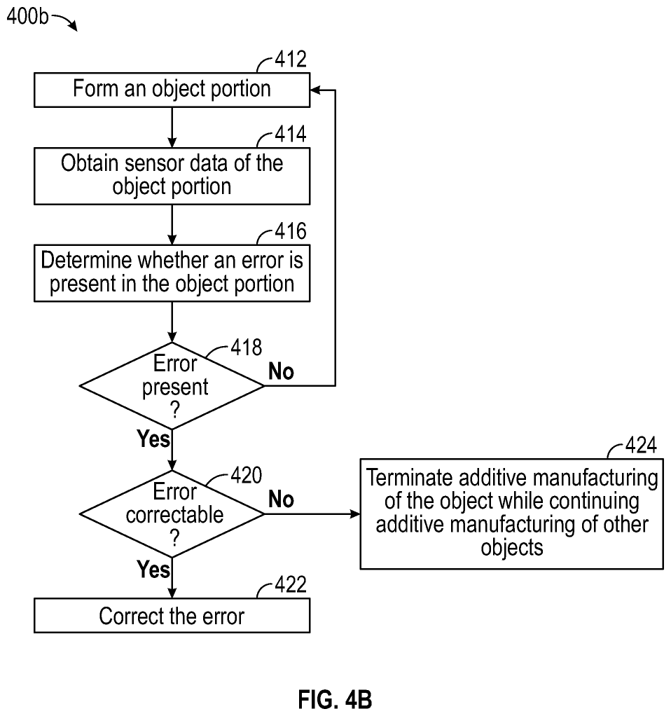

FIGS. 2-4B provide a representative example of an additive manufacturing system with error correction functionality and associated methods, in accordance with embodiments of the present technology. Specifically, FIG. 2 is a partially schematic diagram providing a general overview of an additive manufacturing process, FIGS. 3A-3C are partially schematic side views of an additive manufacturing system that can implement the process of FIG. 2, and FIGS. 4A and 4B are flow diagrams illustrating methods for correcting errors that can be performed using the system of FIGS. 3A-3C. The embodiments of FIGS. 2-4B can be incorporated into the system 100A of FIG. 1A, the system 100B of FIG. 1B, and/or the system 100C of FIG. 1C, and/or combined with any of the other embodiments described herein.

Referring first to FIG. 2, an additive manufacturing process of the present technology can include fabricating an object 202 on a build platform 204 from a series of cured material layers, with each layer having a geometry corresponding to a respective cross-section of the object 202. To fabricate an individual object layer, a layer of curable material 206 (e.g., polymerizable resin) can be brought into contact with the build platform 204 (when fabricating the first layer of the object 202) or with the previously formed portion of the object 202 on the build platform 204 (when fabricating subsequent layers of the object 202). In some embodiments, the curable material 206 is formed on and supported by a substrate (not shown), such as a film. Energy 208 (e.g., light) from an energy source 210 (e.g., a projector or light engine) is then applied to the curable material 206 to form a cured material layer 212 on the build platform 204 or on the object 202. The remaining curable material 206 can then be moved away from the build platform 204 (e.g., by lowering the build platform 204, by moving the build platform 204 laterally, by raising the curable material 206, and/or by moving the curable material 206 laterally), thus leaving the cured material layer 212 in place on the build platform 204 and/or object 202. The fabrication process can then be repeated with a fresh layer of curable material 206 to build up the next layer of the object 202. Although FIG. 2 illustrates a particular type of process to fabricate an object, as discussed elsewhere herein, any suitable process (e.g., vat photopolymerization) can be used to fabricate an object.

Various types of errors can occur during the additive manufacturing process shown in FIG. 2. For example, if the energy 208 is applied to an incorrect location on the curable material 206 and/or the energy 208 is not applied to a correct location on the curable material 206, the actual geometry of cured material 212 of the object 202 can deviate from the target geometry for the object 202. Errors affecting the geometry of the object 202 can also occur if the cured material 212 deforms, delaminates, or otherwise moves away from the intended location after the energy 208 has been applied.

FIGS. 3A-3C illustrate a system 300 for additive manufacturing configured in accordance with embodiments of the present technology. Specifically, FIG. 3A is a partially schematic side view of the system 300, and FIGS. 3B and 3C are partially schematic side views of the system 300 during various stages of operation. The system 300 is configured to fabricate one or more objects 304 using an additive manufacturing process (a single object 304 is shown in FIGS. 3A-3C merely for purposes of simplicity). The additive manufacturing process implemented by the system 300 can be generally similar to the process described in connection with FIG. 2. As described in detail below, the system 300 can detect and/or correct errors that may arise during the additive manufacturing process. In some embodiments, the detection and/or correction are performed automatically by the system 300 with little or no intervention from a human operator, thus improving the reliability and scalability of the additive manufacturing process.

Referring first to FIG. 3A, the system 300 includes a printer assembly 302 that forms the object 304 on a build platform 308 (e.g., a tray, plate, film, sheet, printer bed, or other planar substrate) by applying energy to a curable material 306 (e.g., a photopolymerizable resin). In the illustrated embodiment, the printer assembly 302 includes a carrier film 310 configured to deliver the curable material 306 to the build platform 308. The carrier film 310 can be a flexible loop of material having an outer surface and an inner surface. The outer surface of the carrier film 310 can adhere to and carry a thin layer of the curable material 306. The inner surface of the carrier film 310 can contact one or more rollers 312a-312d that rotate to move the carrier film 310 in a continuous loop trajectory, e.g., along the direction indicated by arrow 314a.

The printer assembly 302 can also include a material source 316 (shown schematically) configured to apply the curable material 306 to the carrier film 310 at a deposition zone 318 (also known as a “coating zone”). In the illustrated embodiment, the material source 316 is located at the upper portion of the printer assembly 302, and the deposition zone 318 is an upper horizontal segment of the carrier film 310 between rollers 312a and 312d. In other embodiments, however, the material source 316 and/or deposition zone 318 can be at different locations in the printer assembly 302. The material source 316 can include nozzles, ports, reservoirs, etc., that deposit the curable material 306 onto the outer surface of the carrier film 310. The system 300 can also include one or more blades 320 (e.g., doctor blades, recoater blades) that smooth the deposited curable material 306 into a relatively thin, uniform layer. For example, the curable material 306 can be formed into a layer having a thickness within a range from 100 microns to 500 microns, 200 microns to 300 microns, or any other desired thickness.

The curable material 306 can be conveyed by the carrier film 310 toward the build platform 308. In some embodiments, the curable material 306 is transported through a pre-print zone 322 downstream of the deposition zone 318. Although the pre-print zone 322 is illustrated as being a vertical segment of the carrier film 310 between the rollers 312a and 312b, in other embodiments, the system 300 can include one or more rollers between the rollers 312a and 312b that are horizontally offset from one or both of the rollers 312a and 312b to create one or more angled segments within the pre-print zone 322.

The build platform 308 can be located proximate to a print zone 324 of the carrier film 310. In the illustrated embodiment, the build platform 308 is located below the printer assembly 302, and the print zone 324 is a lower horizontal segment of the carrier film 310 between rollers 312b and 312c. In other embodiments, however, the build platform 308 and/or print zone 324 can be positioned at different locations in the printer assembly 302. The distance between the carrier film 310 and build platform 308 can be adjustable so that the curable material 306 at the print zone 324 can be brought into direct contact with the surface of the build platform 308 (when printing the initial layer of the object 304) or with the surface of the object 304 (when printing subsequent layers of the object 304). For example, the build platform 308 can include or be coupled to a motor (not shown) that raises and/or lowers the build platform 308 to the desired height during the manufacturing process. Alternatively or in combination, the printer assembly 302 can include or a be coupled to a motor (not shown) that raises and/or lowers to the printer assembly 302 relative to the build platform 308.

The printer assembly 302 includes an energy source 326 (e.g., a projector or light engine) that outputs energy 328 (e.g., light, such as UV light) having a wavelength configured to partially or fully cure the curable material 306. The carrier film 310 can be partially or completely transparent to the wavelength of the energy 328 to allow the energy 328 to pass through the carrier film 310 and onto the portion of the curable material 306 above the build platform 308. Optionally, a transparent plate 330 can be disposed between the energy source 326 and the carrier film 310 to guide the carrier film 310 into a specific position (e.g., height) relative to the build platform 308. During operation, the energy 328 can be patterned or scanned in a suitable pattern onto the curable material 306, thus forming a layer of cured material 332 onto the build platform 308 and/or on a previously formed portion of the object 304. The geometry of the cured material 332 can correspond to the desired cross-sectional geometry for the object 304. The parameters for operating the energy source 326 (e.g., exposure time, exposure pattern, exposure wavelength, energy density, power density) can be set based on instructions from a controller 334, as described in further detail below.

In some embodiments, the energy 328 is applied to the curable material 306 while the carrier film 310 moves to circulate the curable material 306 through the print zone 324. To maintain zero or substantially zero relative velocity between the curable material 306 and the build platform 308, the printer assembly 302 can concurrently move horizontally relative to the build platform 308 along the direction of arrow 314b. The motion of the printer assembly 302 can also increase the printable surface area of the build platform 308. The energy 328 output by the energy source 326 can be coordinated with the movement of the carrier film 310 and build platform 308 so that the layer of cured material 332 is formed with the correct geometry. For example, the energy source 326 can be a scrolling light engine (e.g., scrolling DLP) that outputs the energy 328 in a pattern that varies over time to match the motion of the printer assembly 302 and carrier film 310. In other embodiments, however, the printer assembly 302 can be a stationary device that does not move relative to the build platform 308 while the energy 328 is being applied to the curable material 306.

After curing, the newly formed layer of cured material 332 can be separated from the carrier film 310 and the remaining curable material 306 at the print zone 324. In some embodiments, the separation occurs at least in part due to peel forces produced by the carrier film 310 wrapping around the roller 312c immediately downstream of the print zone 324. The remaining curable material 306 can be conveyed by the carrier film 310 away from the build platform 308, and into a post-print zone 336 downstream of the print zone 324. Although the post-print zone 336 is illustrated as being a vertical segment of the carrier film 310 between the rollers 312c and 312d, in other embodiments, the system 300 can include one or more rollers between the rollers 312c and 312d that are horizontally offset from one or both of the rollers 312c and 312d to create one or more angled segments within the post-print zone 336. The presence of an angled segment of carrier film 310 immediately downstream of the print zone 324 can adjust the peel angle produced by the roller 312c, and thus, the peel force applied to the cured material 332, to enhance separation from the surrounding curable material 306.

The remaining curable material 306 conveyed away from the build platform 308 can be circulated by the carrier film 310 back toward the deposition zone 318. At the deposition zone 318, the material source 316 can apply additional curable material 306 onto the carrier film 310 and/or smooth the curable material 306 to re-form a uniform layer of curable material 306 on the carrier film 310. The curable material 306 can then be recirculated back through the pre-print zone 322, and then to the print zone 324 and build platform 308 to fabricate subsequent layers of the object 304. This process can be repeated to iteratively build up individual object layers on the build platform 308 until the object 304 is complete. The object 304 and build platform 308 can then be removed from the system 300 for post-processing.

Optionally, the printer assembly 302 can be configured to produce the object 304 via a high temperature lithography process utilizing a highly viscous resin. In such embodiments, the printer assembly 302 can include one or more heat sources (heating plates, infrared lamps, etc.—not shown) for heating the curable material 306 to lower the viscosity to a range suitable for additive manufacturing. The heat sources can be positioned near or in direct contact with the carrier film 310 to heat the curable material 306 supported by the carrier film 310. The heat sources can be located at any suitable portion of the printer assembly 302, such as on or within the build platform 308, on or within the material source 316, at the deposition zone 318, at the pre-print zone 322, at the print zone 324, at the post-print zone 336, or combinations thereof.

The system 300 also includes an error correction assembly configured to monitor the object 304 for printing errors and, if appropriate, take actions to correct or otherwise mitigate any detected errors. In some embodiments, the error correction assembly includes an imaging device 338 that obtains image data of at least a portion of the object 304, and a material removal device 340 that removes some or all of the imaged portion of the object 304 to correct the error. The imaging device 338 and material removal device 340 are depicted schematically in FIG. 3A merely for purposes of simplicity.

The imaging device 338 can be or include a camera, scanner, or other device suitable for capturing 2D and/or 3D image data depicting the geometry of at least a portion of the object 304. The image data produced by the imaging device 338 can be transmitted to the controller 334 for performing error detection, as described in greater detail below. In the illustrated embodiment, the imaging device 338 is positioned at one side of the printer assembly 302, such as proximate to the post-print zone 336, and oriented toward the upper surface of the build platform 308. In other embodiments, the imaging device 338 can be positioned at a different location relative to the printer assembly 302, such as proximate to the pre-print zone 322 or proximate to the print zone 324.

The material removal device 340 can be or include an ablation mechanism including an energy source (e.g., a high energy laser) that can remove cured material 332 from the object 304 by outputting energy to ablate the cured material 332, as described in greater detail below. In the illustrated embodiment, the material removal device 340 is positioned at one side of the printer assembly 302, such as a side opposite the side including the imaging device 338. For example, the material removal device 340 can be positioned proximate to the pre-print zone 322 and oriented toward the upper surface of the build platform 308. In other embodiments, the material removal device 340 can be positioned at a different location relative to the printer assembly 302, such as proximate to the pre-print zone 322 or proximate to the print zone 324.

The error correction assembly, including the imaging device 338 and the material removal device 340, can be mechanically coupled to the printer assembly 302 so that the error correction assembly moves together with the printer assembly 302. For instance, the components of the error correction assembly can be configured as a “backpack”-type unit that is carried by the printer assembly 302. Alternatively, the error correction assembly can be mechanically coupled to a different component of the system 300 (e.g., a housing containing the first printer assembly 302, or a separate movable carriage within the housing—not shown) so that the error correction assembly is movable independently of the printer assembly 302 or remains stationary. The imaging device 338 can have a fixed position and/or orientation so that the field of view of the imaging device 338 remains constant, or can have an adjustable position and/or orientation so that the field of view of the imaging device 338 can be varied. Similarly, the material removal device 340 can have a fixed position and/or orientation so that the working field of the material removal device 340 remains constant, or can have an adjustable position and/or orientation so that the working field of the material removal device 340 can be varied.

The controller 334 (shown schematically) is operably coupled to the printer assembly 302 (e.g., to the build platform 308, rollers 312a-312d, material source 316, and/or energy source 326) and error correction assembly (e.g., to the imaging device 338 and material removal device 340) to control the operation thereof. The controller 334 can be or include a computing device including one or more processors and memory storing instructions for performing the additive manufacturing, error detection, and error correction operations described herein. For example, the controller 334 can receive a digital representation of the object 304 to be fabricated and can transmit instructions to the energy source 326 to apply energy 328 to the curable material 306 to form the object cross-sections. As previously discussed, the controller 334 can control various operational parameters of the energy source 326, such as the exposure time, exposure pattern, exposure wavelength, energy density, power density, and/or other parameters affecting the printing process. Optionally, the controller 334 can also determine and control other operational parameters, such as the positioning of the printer assembly 302 (e.g., vertical and/or horizontal position) relative to the build platform 308, the movement speed and/or direction of the carrier film 310, the rotational speed and/or direction of the rollers 312a-312d, the amount of curable material 306 deposited by the material source 316, the thickness of the curable material 306 on the carrier film 310, and/or the amount of heating applied to the curable material 306. Additionally, the controller 334 can operate to detect and/or correct errors in the object 304 via the error correction assembly.

FIGS. 3B and 3C illustrate the operation of the system 300 to detect and correct errors, in accordance with embodiments of the present technology. Selected components of the system 300 (e.g., the controller 334) are omitted in FIGS. 3B and 3C merely for purposes of simplicity.

FIG. 3B illustrates a first stage of operation of the system 300 in which the imaging device 338 generates image data of a portion of the object 304 (“object portion 342”). The first stage can occur after the object portion 342 has been formed by applying energy to the curable material 306 on the carrier film 310 to form a layer of cured material 332, in accordance with the additive manufacturing techniques described herein. As discussed, the printer assembly 302 can be a movable component that translates laterally relative to the build platform 308 (e.g., along a first direction indicated by arrow 344) so that the carrier film 310 remains stationary relative to the build platform 308 during printing and/or to increase the surface area of the build platform 308 that is accessible to the printer assembly 302. In some embodiments, the imaging device 338 and material removal device 340 are coupled to the printer assembly 302 so that these components translate laterally relative to the build platform 308 along with the printer assembly 302. In other embodiments, the build platform 308 can be configured to move laterally while the printer assembly 302 (and the imaging device 338 and the material removal device 340) remains stationary. Optionally, both the build platform 308 (and the imaging device 338 and the material removal device 340) and the printer assembly 302 can be configured to move laterally.

The printer assembly 302 and imaging device 338 can be moved laterally so that the object portion 342 enters the field of view of the imaging device 338. The imaging device 338 can generate image data including one or more images of the object portion 342, such as one or more still images, a stream of video images, etc. The image data can be transmitted to the controller 334 for processing and analysis. For instance, the controller 334 can analyze the image data (e.g., using computer vision algorithms and/or machine learning algorithms) to determine whether any errors are present in the object portion 342. In some embodiments, the controller 334 detects the presence of errors by comparing the image data to a digital representation of a target geometry of the object portion 342 (e.g., a 3D model and/or 2D image of the object portion 342). If the comparison indicates that the actual geometry of the object portion 342 represented in the image data differs from the target geometry, this can indicate the presence of errors, such as locations where cured material 332 should not be present in the object portion 342 and/or locations where cured material 332 is missing from the object portion 342. In some embodiments, the controller 334 determines both the type of error (e.g., missing material or excess material) as well as the location of the error (e.g., the pixel or voxel coordinates of the error within the object portion 342). Alternatively, the controller 334 can make a determination about a presence and/or an absence of an error in the object portion 342 without identifying the exact location of the error.

Alternatively or in combination, the controller 334 can use other types of sensor data to detect whether an error is present in the object portion 342. For instance, the controller 334 can be operably coupled to one or more sensors that monitor a velocity, acceleration, force, and/or torque of at least one movable component of the system 300. The movable component(s) can include, for example, the printer assembly 302, one or more motors (not shown) that drive movement of the printer assembly 302 relative to the build platform 308, the carrier film 310, the rollers 312a-312d, one or more motors (not shown) that drive rotation of the rollers 312a-312d, or suitable combinations thereof. In some embodiments, changes in the velocity, acceleration, force, and/or torque of the movable component(s) are correlated to the presence of errors in the object portion 342, e.g., the velocity, acceleration, force, and/or torque may increase if excess material is deposited and may decrease if too little material is deposited. Optionally, multiple types of sensor data can be analyzed in combination to detect whether an error is present in the object portion 342.

FIG. 3C illustrates a second stage of operation of the system 300 in which the material removal device 340 removes at least some of the object portion 342 to correct an error. The printer assembly 302 can be translated laterally relative to the build platform 308 (e.g., along a second, opposite direction indicated by arrow 346) to return the printer assembly 302 to a starting position for forming the next layer of the object 304. The material removal device 340 can move laterally along with the printer assembly 302 so that the object portion 342 enters the working field of the material removal device 340. If the controller 334 previously determined that the object portion 342 includes erroneously deposited material, the controller 334 can instruct the material removal device 340 to output energy 348 (e.g., a laser beam) to remove the erroneously deposited material from the object portion 342 by ablating some or all of the object portion 342. In embodiments where the specific location of the error is known, the energy 348 can be targeted to that location to selectively ablate only the region of the object portion 342 that includes the error, while leaving remaining regions of the object portion 342 intact. Alternatively, the energy 348 can be used to ablate the entire object portion 342.

After the ablation process is complete, the system 300 can then continue with forming the next portion of the object 304 using the printer assembly 302. If the entire object portion 342 was ablated, the system 300 can reform the object portion 342 before forming the next portion. The process of forming an object portion 342, checking the object portion 342 for errors, and correcting any errors that are present can be repeated until the entire object 304 has been formed.

Optionally, after the ablation process is complete, the system 300 can confirm whether the error was successfully corrected, before forming the next portion of the object 304. For example, additional image data of the object portion 342 can be obtained using the imaging device 338 and/or another imaging device (e.g., a second imaging device positioned on the same side of the printer assembly 302 as the material removal device 340). The additional image data can be transmitted to the controller 334, and the controller 334 can analyze the additional image data to determine whether any errors are still present in the object portion 342 (e.g., by comparing the additional image data to the digital representation of the target geometry for the object portion 342). If the comparison indicates that excess material is still present, the controller 334 can instruct the material removal device 340 to apply additional energy 348 to remove the excess material. This process can be repeated until all excess material is successfully removed. If multiple attempts to correct the error are unsuccessful, the controller 334 can terminate printing of the object 304, pause or terminate the entire printing operation, and/or alert an operator that manual intervention is needed.

The configuration of the system 300 shown in FIGS. 3A-3C can be modified in many different ways. For example, although FIGS. 3A-3C illustrate a single imaging device 338, the system 300 can alternatively include a plurality of imaging devices 338 (e.g., two, three, four, five, or more imaging devices 338), which can be positioned at any suitable respective location relative to the printer assembly 302. In embodiments where multiple imaging devices 338 are used, some or all of the imaging devices 338 can generate different types of image data (e.g., images captured at different wavelengths). Moreover, the error correction assembly of the system 300 can alternatively or additionally include other types of sensors, such as sensors configured to detect changes in mass via mechanical perturbations as described herein.

Additionally, although the material removal device 340 is depicted as being an ablation mechanism, other types of material removal devices 340 can be used, such as any of the other embodiments described herein. Although FIGS. 3A-3C illustrate a single material removal device 340, the system 300 can alternatively include a plurality of material removal device 340 (e.g., two, three, four, five, or more material removal devices 340), which can be positioned at any suitable respective location relative to the printer assembly 302. In embodiments where multiple material removal devices 340 are used, some or all of the material removal devices 340 can implement different types of material removal techniques, as described herein. Moreover, although FIGS. 3A-3C depict the material removal device 340 as located on a side of the printer assembly 302 opposite the side with the imaging device 338, the material removal device 340 can alternatively be located at the same side as the imaging device 338. In such embodiments, the material removal device 340 can be operated while the printer assembly 302 is moving along the first direction of arrow 344.

Optionally, some or all of the components of the error correction assembly (e.g., the imaging device 338 and/or the material removal device 340) can be separate from the printer assembly 302, rather than being integrated into and/or otherwise carried by the printer assembly 302. In such embodiments, the error correction assembly can be operated independently of the printer assembly 302. When an error is detected in the object 304, the operation of the printer assembly 302 can be paused, and the error correction assembly can be directed to the location of the error. The error correction assembly can remain at that location until the correction is completed and/or until a predetermined time period has elapsed. If multiple errors are detected, the error correction assembly can be sequentially moved to each error location, until all the errors in the current portion of the object 304 have been corrected. The printer assembly 302 can then resume operating to print the next portion of the object 304.

Moreover, the system 300 may use other types of error correction techniques, in addition or alternatively to using the material removal device 340. For instance, as discussed elsewhere herein, other types of error correction techniques that may be used include reprinting a portion of the object 304 where material was omitted or insufficiently cured, adjusting a digital representation of the object 304 to compensate for the error (e.g., changing the geometry and/or energy parameters of subsequent object layers), adjusting a digital representation of other objects that are printed concurrently with the object 304 to compensate for the error (e.g., changing the geometry and/or energy parameters for the other objects), adjusting an alignment of the printer assembly 302, etc. Optionally, an error correction technique may include discontinuing printing of the object 304 and/or other objects proximate to the object 304 if the error is too severe to be corrected.

FIG. 4A is a flow diagram illustrating a method 400a for manufacturing an object, in accordance with embodiments of the present technology. The method 400a can be performed by any embodiment of the systems and devices described herein, such as the system 300 of FIGS. 3A-3C. In some embodiments, some or all of the processes of the method 400a are implemented as computer-readable instructions (e.g., program code) that are configured to be executed by one or more processors of a computing device, such as the controller 334 of FIGS. 3A-3C.

The method 400a can begin at block 402 with forming an object portion, using an additive manufacturing process implemented by a printer assembly (e.g., the printer assembly 302 of FIGS. 3A-3C). The object portion can be a layer, cross-section, or any other part of the geometry of an additively manufactured object. The object portion can be formed using any suitable additive manufacturing technique described herein. For example, the object portion can be formed by instructing the printer assembly to apply energy to a layer of curable material, according to a digital representation of a target geometry for the object portion. The energy can selectively cure the curable material, thus forming a cured material layer onto a build platform or onto a previously formed portion of the object, as described herein.

At block 404, the method 400a can include obtaining sensor data of the object portion. In some embodiments, the sensor data includes image data, which can be obtained using one or more imaging devices (e.g., the imaging device 338 of FIGS. 3A-3C), and can include 2D and/or 3D data representing the actual geometry of the object portion. The image data can include one or more images of the object portion in any suitable wavelength, such as infrared wavelengths, visible wavelengths, ultraviolet wavelengths, or combinations thereof. Alternatively or in combination, the process of block 404 can include obtaining other types of sensor data, as disclosed elsewhere herein. For instance, the sensor data obtained in block 404 can include sensor data indicative of the response of the object portion to mechanical perturbations, and/or sensor data representing the velocity, acceleration, force, and/or torque of a movable component of the printer assembly.

At block 406, the method 400a can continue with determining whether an error is present in the object portion, based on the sensor data. For example, image data can be analyzed using computer vision algorithms, machine learning algorithms, and/or other suitable techniques to detect the presence of errors. In some embodiments, the process of block 406 involves comparing the image data to a digital representation of a target geometry for the object portion (e.g., a 3D model and/or 2D image of the object portion) to determine whether there any differences between the actual geometry of the object portion and the target geometry that are indicative of an error (e.g., missing material or excess material). Optionally, the process of block 406 can further include identifying the coordinate location of the error within the object portion.

At block 408, if no error is present, the method 400a can proceed to block 402 to form the next portion of the object. If an error is determined to be present (e.g., the object portion includes material at an undesired location), the method 400a can continue to block 410 to correct the error by removing a region of the object portion. The removed region can be only the region containing the error, can include other regions proximate to the region containing the error (e.g., within 1 mm, 2 mm, 3 mm, 4 mm, 5 mm, or 1 cm of the location of the error), or can be the entire object portion. The region of the object portion can be corrected using any suitable material removal technique described herein. In some embodiments, for example, the process of block 408 involves instructing a material removal device (e.g., the material removal device 340 of FIGS. 3A-3C) to apply energy to the object portion to selectively ablate the material at one or more specific locations, or to non-selectively ablate the entirety of the object portion.

Once the error has been corrected, the method 400a can return to block 402 to form the next object portion. The method 400a can then be repeated until the entire object has been formed.

The method 400a can be modified in many different ways. For example, the method 400a can include additional processes not shown in FIG. 4A. In some embodiments, depending on the type of error, the method 400a can correct the error using other processes besides the process of block 410. For instance, if the error involves missing material at a particular location of the object portion, the method 400a can correct the error by operating the printer assembly to reapply material to that location. Additionally, the method 400a can involve confirming that the error was successfully corrected (e.g., based on additional image data and/or other sensor data) before continuing to block 402 to form the next object portion, as described herein.

FIG. 4B is a flow diagram illustrating a method 400b for manufacturing an object, in accordance with embodiments of the present technology. The method 400b can be performed by any embodiment of the systems and devices described herein, such as the system 300 of FIGS. 3A-3C. In some embodiments, some or all of the processes of the method 400b are implemented as computer-readable instructions (e.g., program code) that are configured to be executed by one or more processors of a computing device, such as the controller 334 of FIGS. 3A-3C.

The method 400b can include forming an object portion (block 412), obtaining sensor data of the object portion (block 414), and determining whether an error is present in the object portion (block 416). The processes of blocks 412, 414, and 416 may be identical or generally similar to the processes of blocks 402, 404, and 406 of the method 400a of FIG. 4A.

At block 418, if no error is present, the method 400b can proceed to block 412 to form the next portion of the object. If an error is determined to be present, the method 400b can instead continue to block 420 with determining whether the error is correctable. The determination can be based on the size of the error (e.g., errors that are too large may be considered uncorrectable), the location of the error (e.g., errors that occur at critical locations of the object may be considered uncorrectable), the type of error (e.g., whether the error involves omission of material, deposition of excess material, insufficient curing of material, overcuring of material), and/or other relevant considerations. In some embodiments, the error is considered correctable if the additive manufacturing system includes error correction capabilities suitable for addressing the error (e.g., a material removal device for removing incorrectly deposited material), and is considered uncorrectable if the additive manufacturing system does not include error correction capabilities suitable for addressing the error and/or it is determined that manual intervention by a human operator is needed to correct the error.

If the error is correctable, the method 400b can continue to block 422 to correct the error. The error may be corrected in various ways, such as by removing a region of the object portion to compensate for incorrectly deposited material (e.g., as previously described with respect to block 410 of the method 400a of FIG. 4A), depositing additional material to compensate for omission of material, applying additional energy to compensate for insufficient curing, adjusting the digital representation of the object (e.g., changing the geometry and/or energy parameters for the current object slice or for subsequent object slices), adjusting the digital representation of other objects proximate to the object, or suitable combinations thereof. The error correction technique used may depend on the size, location, and/or type of error that occurred, as well as the available error correction capabilities of the additive manufacturing system. Once the error has been corrected, the method 400b can return to block 412 to form the next object portion. The method 400b can then be repeated until the entire object has been formed.

If the error is not correctable, the method 400b can instead continue to block 424 to terminate additive manufacturing of the object containing the error, while continuing additive manufacturing of other objects that are being concurrently fabricated on the same build platform. In some embodiments, it may be advantageous to continue printing other objects that are not affected by the error to maintain high manufacturing throughput, while selectively terminating the printing of the object having the error to conserve materials that would be consumed in attempting to print that object and/or to reduce the likelihood of the error affecting the printing of the other objects. Optionally, the process of block 424 can also include terminating the additive manufacturing of one or more objects that are proximate to the object affected by the error (e.g., objects within the same zone or quadrant of the build platform as the affected object), while continuing the additive manufacturing of one or more objects that are sufficiently far away from the affected object (e.g., objects in a different zone or quadrant of the build platform as the affected object).

The process of block 424 can be implemented in various ways. For example, the additive manufacturing of one or more objects may be terminated by removing those objects from fabrication instructions (e.g., the file containing the object slices or other digital representation) that are used to control the additive manufacturing system. The removal can be performed via a masking process, e.g., as discussed further below in connection with FIGS. 8A-9B. As another example, in embodiments where the additive manufacturing system includes multiple energy sources, with each energy source configured to apply energy to a respective zone of the build platform to fabricate one or more objects within that zone, the additive manufacturing of the object affected by the error and/or objects proximate to the affected object may be terminated by deactivating the energy source associated with the zone of the affected object. Subsequently, the processes of the method 400b can be repeated for the remaining objects on the build platform to complete the additive manufacturing of the remaining objects.

The method 400b can be modified in many different ways. For example, the method 400b can include additional processes not shown in FIG. 4B, such as confirming that the error was successfully corrected (e.g., based on additional sensor data) before continuing to block 412 to form the next object portion, as described herein.

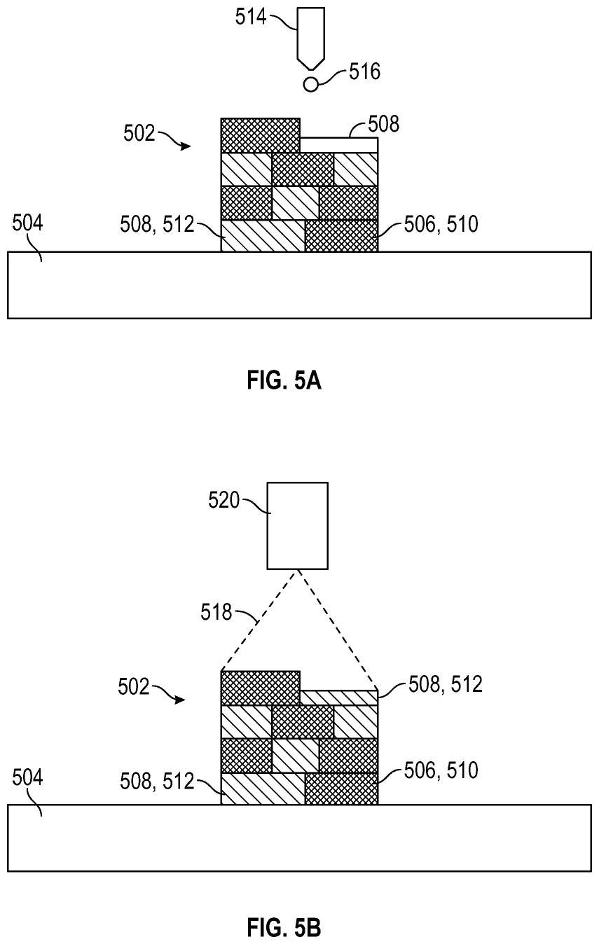

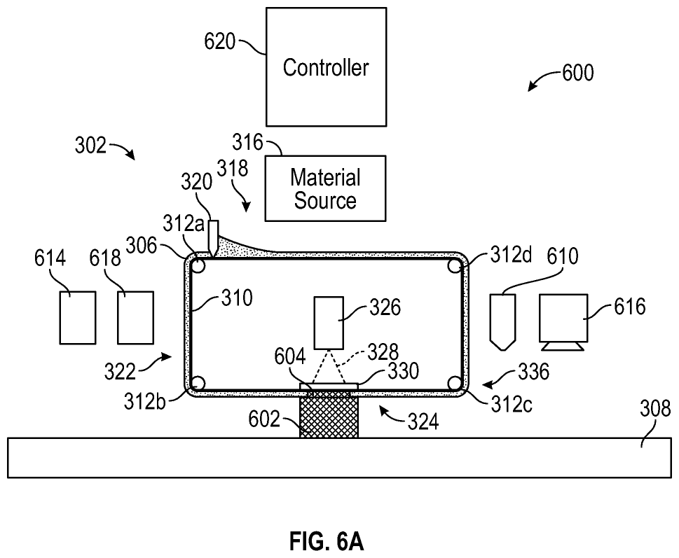

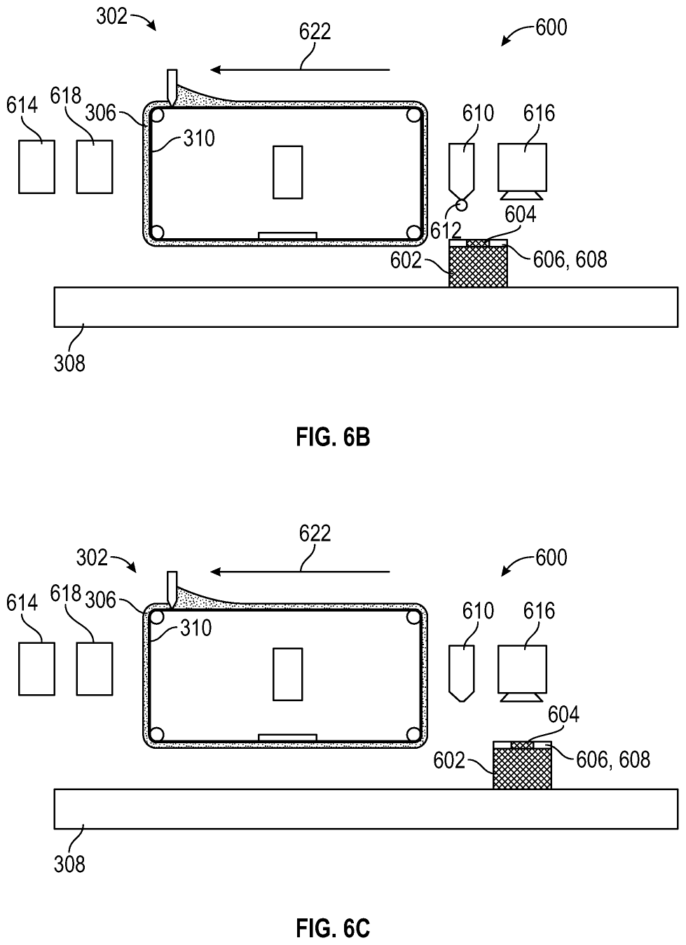

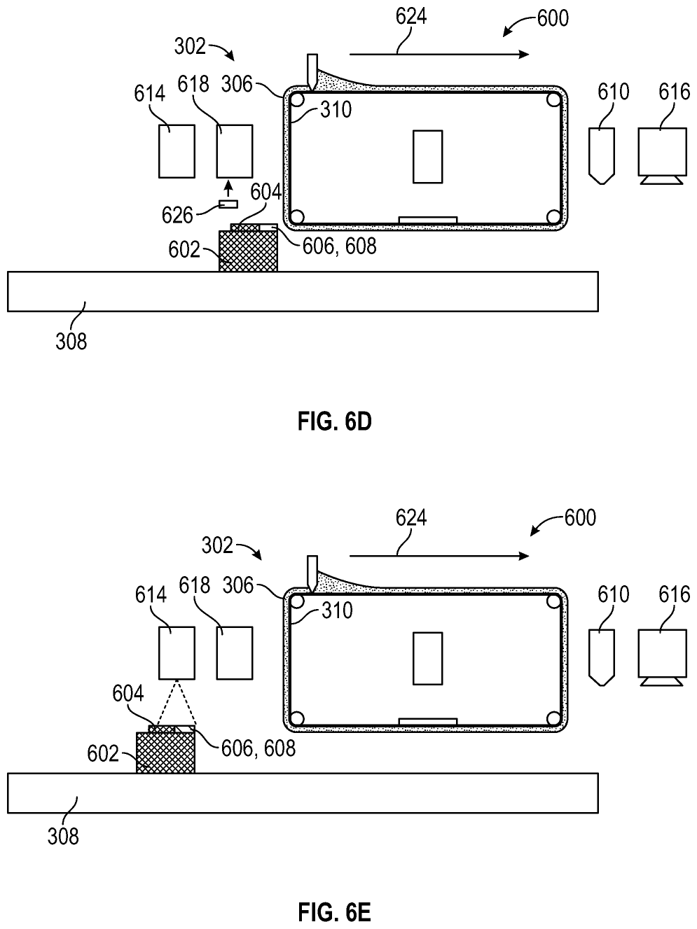

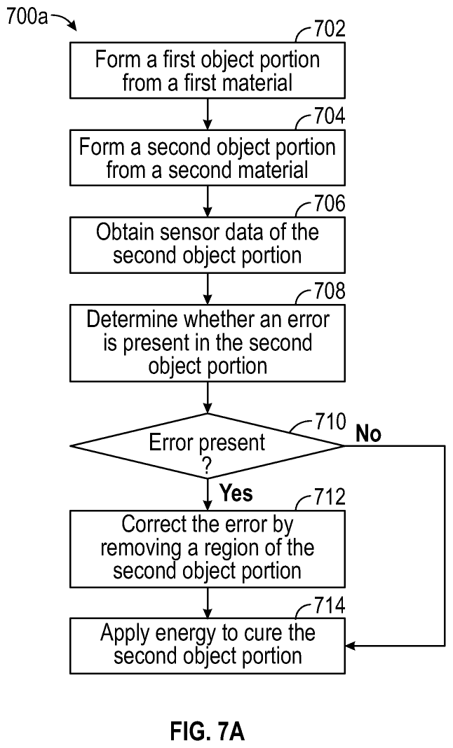

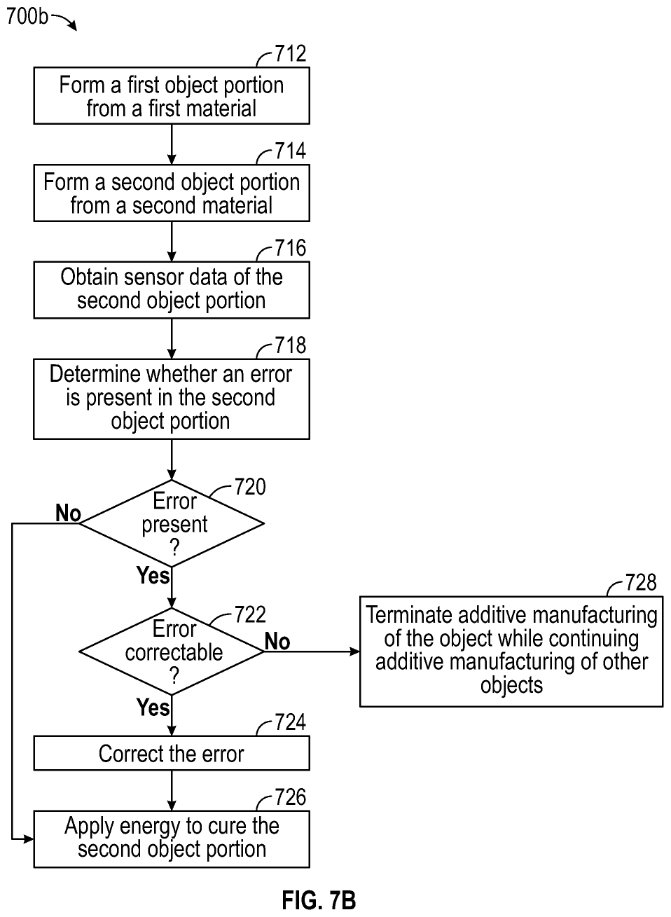

FIGS. 5A-7B provide another representative example of an additive manufacturing system with error correction functionality and associated methods, in accordance with embodiments of the present technology. Specifically, FIGS. 5A and 5B are partially schematic diagrams providing a general overview of a hybrid additive manufacturing process, FIGS. 6A-6E are partially schematic side views of an additive manufacturing system that can implement the process of FIGS. 5A and 5B, and FIGS. 7A and 7B are flow diagrams illustrating methods for correcting errors that can be performed using the system of FIGS. 6A-6E. The embodiments of FIGS. 5A-7B can be incorporated into the system 100A of FIG. 1A, the system 100B of FIG. 1B, and/or the system 100C of FIG. 1C, and/or combined with any of the other embodiments described herein.

Referring first to FIG. 5A, a hybrid additive manufacturing process of the present technology can include fabricating an object 502 on a build platform 504 from two or more materials, such as a first curable material 506 and a second curable material 508. The first curable material 506 can be a different material than the second curable material 508, and/or can be deposited using a different additive manufacturing technique than the second curable material 508. The object 502 can be built up from one or more first object portions 510 formed from the first curable material 506, and one or more second object portions 512 formed from the second curable material 508. The first object portions 510 can differ from the second object portions 512 with respect to at least one material property, such as one or more of the following: modulus (e.g., clastic modulus, flexural modulus, storage modulus), glass transition temperature, elongation to break, elongation to yield, strength, solubility, hardness, scratch resistance, roughness, degradability, color, refractive index, energy absorption, energy dissipation, energy reflection, energy scatter, transparency, diffusion, pH, porosity, morphology, chemical composition, molecular recognition, molecular absorption, molecular release, phase separation, morphology, or durability.

For example, in some embodiments, the first curable material 506 is a polymerizable resin that is provided as a layer (e.g., on a carrier film), and energy is selectively applied to the layer (e.g., using SLA or DLP techniques) to cure the first curable material 506 to form the first object portions 510. The process of forming the first object portions 510 can be identical or generally similar to the process described with respect to FIG. 2.

The second curable material 508 can be a polymerizable fluid (e.g., a resin or liquid) suitable for use in a material jetting process (e.g., an inkjet 3D printing process). In some embodiments, the second curable material 508 is deposited using at least one nozzle 514 that produces a plurality of droplets 516 of the second curable material 508. The droplets 516 can be deposited onto the surface of the build platform 504, or onto a previously formed portion of the object 502 (e.g., a previously formed first object portion 510 or a previously formed second object portion 512). Depending on the properties (e.g., surface energy, rheological properties) and placement of the droplets 516, the droplets 516 can coalesce with other deposited droplets 516 to form a uniform layer of the second curable material 508 (e.g., as shown in FIG. 5A), or can remain as discrete droplets 516. For example, if the second curable material 508 is a relatively viscous and/or thixotropic material, the droplets 516 of the second curable material 508 can retain the same shape or a similar shape once deposited.

Referring next to FIG. 5B, after the droplets 516 of the second curable material 508 have been deposited, energy 518 (e.g., light) from an energy source 520 (e.g., a projector, light engine, lamp) is then applied to the second curable material 508 to cure the second curable material 508 into a new second object portion 512. In the illustrated embodiment, the energy source 520 applies the energy 518 to an area larger than the area of the second object portion 512, while in other embodiments, the energy source 520 can selectively apply the energy 518 to the area of the second object portion 512 only. The energy 518 can be the same type of energy used to cure the first curable material 506, or can be a different type of energy (e.g., a different wavelength). The energy source 520 can be the same as the energy source used to cure the first curable material 506, or can be a different energy source.

The object 502 can be fabricated by sequentially or concurrently depositing the first curable material 506 and the second curable material 508 to form the first object portions 510 and second object portions 512, respectively. In some embodiments, the object 502 is built up in a plurality of layers, with each layer being formed entirely from the first curable material 506, entirely from the second curable material 508, or a combination of the first curable material 506 and the second curable material 508. If the droplet size of the second curable material 508 is smaller than the intended thickness of an individual layer of the object 502 (e.g., which may be the same or similar to the thickness of an individual layer of the first curable material 506), multiple layers of droplets 516 can be sequentially applied and cured, until the height of the corresponding second object portion 512 reaches the intended layer thickness. For instance, the size of an individual droplet 516 of the second curable material 508 can be within a range from 5 microns to 20 microns (e.g., 10 microns to 15 microns), and the thickness of an individual layer of the object 502 and/or an individual layer of the first curable material 506 can be within a range from 100 microns to 500 microns (e.g., 200 microns to 300 microns).

FIGS. 6A-6E illustrate a system 600 for additive manufacturing configured in accordance with embodiments of the present technology. Specifically, FIG. 6A is a partially schematic side view of the system 600, and FIGS. 6B-6E are partially schematic side views of the system 600 during various stages of operation. The system 600 is configured to fabricate one or more objects 602 using a hybrid additive manufacturing process (a single object 602 is shown in FIGS. 6A-6E merely for purposes of simplicity). The hybrid additive manufacturing process implemented by the system 600 can be generally similar to the process described in connection with FIGS. 5A and 5B. As described in detail below, the system 600 can detect and/or correct errors that may arise during the hybrid additive manufacturing process. In some embodiments, the detection and/or correction are performed automatically by the system 600 with little or no intervention from a human operator, thus improving the reliability and scalability of the hybrid additive manufacturing process.

Referring first to FIG. 6A, the system includes a first printer assembly 302 configured to fabricate at least a first portion of an object 602 (“first object portion 604”) from a first curable material 306 (e.g., a polymerizable resin) using a first additive manufacturing process. The operation of the first printer assembly 302 can be generally similar to that of the embodiment described with respect to FIGS. 3A-3C, such that identical reference numbers in FIGS. 3A-3C and FIGS. 6A-6E indicate identical or similar components. For example, the first printer assembly 302 can include a carrier film 310 that moves on rollers 312a-312d to circulate the first curable material 306 through a deposition zone 318, pre-print zone 322, print zone 324, and post-print zone 336. Energy 328 can be applied to the first curable material 306 at the print zone 324 to cure the first curable material 306 into the first object portion 604, as described elsewhere herein.

Referring to FIGS. 6A and 6B together, the system 600 also includes a second printer assembly configured to fabricate at least a second portion of the object 602 (“second object portion 606”) from a second curable material 608 (e.g., a polymerizable fluid) using a second additive manufacturing process (e.g., an inkjet printing process or other material jetting process). The second curable material 608 can be different from the first curable material 306, and/or the second additive manufacturing process can be different from the first additive manufacturing process. The second object portion 606 can differ from the first object portion 604 with respect to at least one material property, such as one or more of the following: modulus, glass transition temperature, elongation to break, elongation to yield, strength, solubility, hardness, scratch resistance, roughness, degradability, color, refractive index, energy absorption, energy dissipation, energy reflection, energy scatter, transparency, diffusion, pH, porosity, morphology, chemical composition, molecular recognition, molecular absorption, molecular release, phase separation, morphology, or durability.

The second printer assembly can include at least one nozzle 610 that deposits the second curable material 608 according to the desired geometry for the second object portion 606, and a second energy source 614 that applies energy to cure the second curable material 608 of the second object portion 606, as described in further detail below. The nozzle 610 can be fluidly coupled to a source of the second curable material 608 (e.g., a reservoir, vat, or other container—not shown). The nozzle 610 can output the second curable material 608 as a plurality of discrete droplets 612. The size of the droplets 612 can be varied as desired, e.g., the droplet diameter can be within a range from 5 microns to 50 microns, such as 10 microns to 15 microns.

In the illustrated embodiment, the nozzle 610 is positioned at one side of the first printer assembly 302, such as proximate to the post-print zone 336, and oriented toward the upper surface of the build platform 308. The second energy source 614 can be positioned at one side of the first printer assembly 302, such as a side opposite the side including the nozzle 610. For example, the second energy source 614 can be proximate to the pre-print zone 322 and oriented toward the upper surface of the build platform 308. In other embodiments, the nozzle 610 and second energy source 614 can be positioned at the same side of the first printer assembly 302, or at any other suitable location relative to the first printer assembly 302.

The second printer assembly, including the nozzle 610 and second energy source 614, can be mechanically coupled to the first printer assembly 302 so that the second printer assembly moves together with the first printer assembly 302. For instance, the components of the second printer assembly can be configured as a “backpack”-type unit that is carried by the first printer assembly 302. Alternatively, the second printer assembly can be mechanically coupled to a different component of the system 600 (e.g., a housing containing the first printer assembly 302, or a separate movable carriage within the housing—not shown) so that the second printer assembly is movable independently of the first printer assembly 302 or remains stationary.

In some embodiments, the system 600 also includes an error correction assembly configured to monitor the object 602 for printing errors and, if appropriate, take actions to correct or otherwise mitigate any detected errors. The error correction assembly can include an imaging device 616 that obtains image data of at least a portion of the object 602 (e.g., the first object portion 604 and/or the second object portion 606). The imaging device 616 can be or include a camera, scanner, or other device suitable for capturing 2D and/or 3D image data depicting the geometry of at least a portion of the object 304 for performing error detection, as described in greater detail below. The imaging device 616 can be positioned at one side of the first printer assembly 302, such as proximate to the post-print zone 336, and oriented toward the upper surface of the build platform 308. In the illustrated embodiment, the nozzle 610 is interposed between the imaging device 616 and the first printer assembly 302, while in other embodiments, the imaging device 616 can be interposed between the nozzle 610 and the first printer assembly 302, or the imaging device 616 can be at the same lateral position as the nozzle 610.

The error correction assembly can also include a material removal device 618 (shown schematically) including a vacuum mechanism that removes some or all of the imaged portion of the object 602 via suction to correct the error, as described in further detail below. In some embodiments, the material removal device 618 includes an inlet (e.g., a nozzle, hose, or other intake component) that is fluidly coupled to a vacuum pump to allow material to be withdrawn from the surface of the object 602. The material removal device 618 can also include a container interposed between the inlet and vacuum pump to collect the material. The collected material can be disposed, or can be reused in subsequent additive manufacturing operations.

The material removal device 618 can be positioned at one side of the first printer assembly 302, such as a side opposite the side including the imaging device 616. For example, the material removal device 618 can be proximate to the pre-print zone 322 and oriented toward the upper surface of the build platform 308. Although the material removal device 618 is shown as being interposed between the second energy source 614 and the first printer assembly 302, in other embodiments, the second energy source 614 can be interposed between the material removal device 618 and the first printer assembly 302. Moreover, in other embodiments, the second energy source 614 and the material removal device 618 can be positioned at the same side of the first printer assembly 302, or at any other suitable location relative to the first printer assembly 302.

The error correction assembly, including the imaging device 616 and the material removal device 618, can be mechanically coupled to the first printer assembly 302 and/or the second printer assembly so that the error correction assembly moves together with the first printer assembly 302 and/or the second printer assembly. For instance, the components of the error correction assembly can be configured as a “backpack”-type unit that is carried by the first printer assembly 302. Alternatively, the error correction assembly can be mechanically coupled to a different component of the system 600 (e.g., a housing containing the first printer assembly 302 and the second printer assembly, or a separate movable carriage within the housing—not shown) so that the error correction assembly is movable independently of the first printer assembly 302 and/or the second printer assembly, or remains stationary. The imaging device 616 can have a fixed position and/or orientation so that the field of view of the imaging device 616 remains constant, or can have an adjustable position and/or orientation so that the field of view of the imaging device 616 can be varied. Similarly, the material removal device 618 can have a fixed position and/or orientation so that the working field of the material removal device 618 remains constant, or can have an adjustable position and/or orientation so that the working field of the material removal device 618 can be varied.

Referring to FIG. 6A, the system 600 includes a controller 620 (shown schematically) that is operably coupled to the first printer assembly 302, the second printer assembly (e.g., to the nozzle 610 and the second energy source 614), and the error correction assembly (e.g., to the imaging device 616 and the material removal device 618) to control the operations thereof. The controller 620 can be or include a computing device including one or more processors and memory storing instructions for performing the additive manufacturing, error detection, and error correction operations described herein.

For example, the controller 620 can receive a digital representation of the object 602 to be fabricated, including a first digital representation of the first object portion 604 and a second digital representation of the second object portion 606. The controller 620 can transmit instructions to the first printer assembly 302 so the first energy source 326 applies energy 328 to the first curable material 306 to form the first object portion 604, according to the first digital representation. The controller 620 can concurrently or sequentially transmit instructions to the second printer assembly so the nozzle 610 deposits the second curable material 608 to form the second object portion 606, according to the second digital representation, and the second energy source 614 cures the second object portion 606. The controller 334 can control various operational parameters of the first energy source 326 and/or the second energy source 614, such as the exposure time, exposure pattern, exposure wavelength, energy density, power density, and/or other parameters affecting the printing process.

Optionally, the controller 620 can also determine and control other operational parameters, such as the positioning of the first printer assembly 302 (e.g., vertical and/or horizontal position) relative to the build platform 308, the movement speed and/or direction of the carrier film 310, the rotational speed and/or direction of the rollers 312a-312d, the amount of the first curable material 306 deposited by the material source 316, the thickness of the first curable material 306 on the carrier film 310, the amount of heating applied to the first curable material 306, the amount of the second curable material 608 deposited by the nozzle 610, the droplet size of the second curable material 608, and/or the placement location of the second curable material 608. The controller 620 can also operate to detect and/or correct errors in the object 602 via the error correction assembly, as described in detail below.

FIGS. 6B-6E illustrate the operation of the system 600 to perform the second additive manufacturing process, and to detect and correct errors in the object 602, in accordance with embodiments of the present technology. Selected components of the system 600 (e.g., the controller 620) are omitted in FIGS. 6B-6E merely for purposes of simplicity.

FIG. 6B illustrates a first stage of operation of the system 600 in which the nozzle 610 deposits the second curable material 608. The first stage can occur after the first object portion 604 has been formed from the first curable material 306. As described herein, the first printer assembly 302 can be a movable component that translates laterally relative to the build platform 308 (e.g., along a first direction indicated by arrow 622) so that the carrier film 310 remains stationary relative to the build platform 308 during printing and/or to increase the surface area of the build platform 308 that is accessible to the first printer assembly 302. In some embodiments, the second printer assembly and error correction assembly are coupled to the first printer assembly 302 so that these components translate laterally relative to the build platform 308 along with the first printer assembly 302.

The nozzle 610 of the second printer assembly can be moved laterally so that the object 602 enters the working field of the nozzle 610. The nozzle 610 can deposit one or more droplets 612 of the second curable material 608 onto a previously formed portion of the object 602 (or directly onto the build platform 308). In the illustrated embodiment, for example, the second curable material 608 is deposited onto the object 602 after the first printer assembly 302 has formed a first object portion 604 from the first curable material 306.

FIG. 6C illustrates a second stage of operation of the system 600 in which the imaging device 616 generates image data of the second object portion 606. After the second object portion 606 has been formed from the second curable material 608, the first printer assembly 302 can continue to move laterally relative to the build platform 308 (e.g., along the first direction indicated by arrow 622). The imaging device 616 can move laterally with the first printer assembly 302 so that the newly formed second object portion 606 enters the field of view of the imaging device 616. The imaging device 616 can generate image data including one or more images of the second object portion 606, such as one or more still images, a stream of video images, etc.

The image data can be transmitted to the controller 620 for processing and analysis. For instance, the controller 620 can analyze the image data (e.g., using computer vision algorithms and/or machine learning algorithms) to determine whether any errors are present in the second object portion 606. In some embodiments, the image data shows both the second object portion 606 and the first object portion 604, but the second object portion 606 has different optical characteristics than the first object portion 604 so that the second object portion 606 can be distinguished from the first object portion 604 in the image data. For instance, the second object portion 606 can have a different color, opacity, transmissivity, reflectivity, etc., than the first object portion 604 (e.g., due to the presence of dyes or other additives in the second curable material 608 that are not present in the first curable material 306, due to different intrinsic material properties of the different curable materials, etc.). Alternatively or in combination, the image data produced by the imaging device 616 can be obtained at a wavelength in which the visibility of the second object portion 606 is enhanced relative to the first object portion 604, or in which only the second object portion 606 is visible.

In some embodiments, the controller 620 detects the presence of errors by comparing the image data to the second digital representation of the target geometry for the second object portion 606 (e.g., a 3D model and/or 2D image of the second object portion 606). If the comparison indicates that the actual geometry of the second object portion 606 represented in the image data differs from the target geometry, this can indicate the presence of errors, such as locations where the second curable material 608 should not be present in the second object portion 606 and/or locations where the second curable material 608 is missing from the second object portion 606. In some embodiments, the controller 620 determines both the type of error (e.g., missing material or excess material) as well as the location of the error (e.g., the pixel or voxel coordinates of the error within the second object portion 606). Alternatively, the controller 620 can make a determination about the presence and/or absence of an error in the second object portion 606 without identifying the exact location of the error.

FIG. 6D illustrates a third stage of operation of the system 600 in which the material removal device 618 removes at least some of the second object portion 606 to correct an error. The first printer assembly 302 can be translated laterally relative to the build platform 308 (e.g., along a second, opposite direction indicated by the arrow 624) to return the first printer assembly 302 to a starting position for forming the next layer of the object 602. The material removal device 618 can move laterally along with the first printer assembly 302 so that the second object portion 606 enters the working field of the material removal device 618. If the controller 620 previously determined that the second object portion 606 includes erroneously deposited material, the controller 620 can instruct the material removal device 618 to apply a vacuum to remove erroneously deposited material 626 from the second object portion 606 via suction.

In embodiments where the specific location of the error is known, the material removal device 618 can selectively apply vacuum to only the region of the second object portion 606 that includes the error, while leaving remaining regions of the second object portion 606 intact. Alternatively, the entire second object portion 606 can be removed, e.g., if the specific location of the error is unknown and/or if the droplets 612 of the second curable material 608 in the second object portion 606 have coalesced into a continuous fluid layer.

In embodiments where the second curable material 608 is a viscous material (e.g., a resin), the object 602 can optionally be agitated (e.g., vibrated) to reduce the viscosity via shear thinning, to make it easier for the material removal device 618 to remove the second curable material 608 via suction. In such embodiments, an agitator (e.g., a piezoelectric transducer, an acoustic transducer, vibration motor) can be coupled to the build platform 308 to generate mechanical perturbations that are transmitted to the second object portion 606 to reduce the viscosity thereof. Alternatively or in combination, one or more heat sources (e.g., lamps, heating plates, thermoelectric heaters) can apply heat to the second object portion 606 to reduce its viscosity. The heat source(s) can be coupled to the build platform 308 and/or located within the build platform 308 to produce heat that is transmitted to the second object portion 606. Optionally, the heat source(s) can be separate components that are oriented toward the second object portion 606 to apply heat thereto.

Optionally, after the vacuum removal process is complete, the system 600 can confirm whether the error was successfully corrected, before proceeding to the next stage of operation. For example, additional image data of the second object portion 606 can be obtained using the imaging device 616 and/or another imaging device (e.g., a second imaging device positioned on the same side of the first printer assembly 302 as the material removal device 618). The additional image data can be transmitted to the controller 620, and the controller 620 can analyze the additional image data to determine whether any errors are still present in the second object portion 606 (e.g., by comparing the additional image data to the digital representation of the target geometry for the second object portion 606). If the comparison indicates that excess material is still present, the controller 620 can instruct the material removal device 618 to reapply suction to remove the excess material. This process can be repeated until all excess material is successfully removed. If multiple attempts to correct the error are unsuccessful, the controller 620 can terminate printing of the object 602, pause or terminate the entire printing operation, and/or alert an operator that manual intervention is needed.

FIG. 6E illustrates a fourth stage of operation of the system 600 in which the second energy source 614 applies energy to cure the remaining region of the second object portion 606. After the erroneously deposited material 626 has been removed from the second object portion 606, the first printer assembly 302 can continue to move laterally relative to the build platform 308 (e.g., along the second direction indicated by arrow 624). The second energy source 614 can move laterally with the first printer assembly 302 so that the remaining region of the second object portion 606 enters the working field of the second energy source 614. The second energy source 614 can output energy to cure the remaining region of the second object portion 606. If the entire second object portion 606 was removed, the system 600 can skip the curing process, and can instead proceed to reforming the second object portion 606 by depositing additional second curable material 608 via the nozzle 610.

After the curing process is complete, the system 600 can then continue with forming the next portion of the object 602 using the first printer assembly 302 and/or the second printer assembly. The process of forming an object portion, checking the object portion for errors, and correcting any errors that are present can be repeated until the entire object 602 has been formed.

The configuration of the system 600 shown in FIGS. 6A-6E can be modified in many different ways. For example, although FIGS. 6A-6E illustrate a single nozzle 610, the second printer assembly can alternatively include a plurality of nozzles 610 (e.g., two, three, four, five, ten, twenty, or more nozzles 610), which can be arranged in a linear array, a 2D array, or any other suitable configuration. In embodiments where multiple nozzles are used, each nozzle can be fluidly coupled to a respective material source to deposit a different respective curable material, such that the second printer assembly can deposit multiple different types of curable materials. For example, the system may include one or more nozzles configured to deposit the second curable material 608, one or more nozzles configured to deposit a third curable material, etc. In such embodiments, the error correction assembly can be modified to detect and correct errors in some or all of the curable materials deposited by the second printer assembly.

Additionally, although FIGS. 6A-6E illustrate a single imaging device 616, the system 600 can alternatively include a plurality of imaging devices 616 (e.g., two, three, four, five, or more imaging devices 616), which can be positioned at any suitable respective location relative to the first printer assembly 302. In embodiments where multiple imaging devices 616 are used, some or all of the imaging devices 616 can generate different types of image data (e.g., images captured at different wavelengths). Moreover, the error correction assembly of the system 600 can alternatively or additionally include other types of sensors, such as sensors configured to detect changes in mass via mechanical perturbations as described herein.

Although the material removal device 618 is depicted as being a vacuum mechanism, other types of material removal devices 618 can be used, such as any of the other embodiments described herein. For example, the material removal device 618 can alternatively or additionally be configured to remove the erroneously deposited material 626 via electrostatic interactions. In such embodiments, the material removal device 618 can include a chargeable component (e.g., a roller, drum, or screen). An electrical charge opposite the charge of the second curable material 608 can be applied to a portion of or the entire surface of the chargeable component. The charged surface can then be brought into proximity with the material to remove the erroneously deposited material 626 material from the second object portion 606. The material can then be removed from the charged surface (e.g., via scraping, washing, solvents, removing the charge from the charged surface) and collected for disposal or reuse.

Moreover, although FIGS. 6A-6E illustrate a single material removal device 618, the system 600 can alternatively include a plurality of material removal devices 618 (e.g., two, three, four, five, or more material removal devices 618), which can be positioned at any suitable respective location relative to the first printer assembly 302. In embodiments where multiple material removal devices 618 are used, some or all of the material removal devices 618 can implement different types of material removal techniques, as described herein. For instance, a first material removal device 618 can be used to correct errors in the first object portion 604 (e.g., via ablation), while a second material removal device 618 can be used to correct errors in the second object portion 606 (e.g., via suction and/or electrostatic interactions).

In some embodiments, the system 600 can be modified so that the erroneously deposited material 626 is removed after the second energy source 614 applies energy to cure the second object portion 606. For example, the second energy source 614 can be a projector, light engine, or other device configured to selectively apply energy to only those locations corresponding to the target geometry for the second object portion 606. Accordingly, any erroneously deposited material 626 can remain uncured, and can be subsequently removed via the material removal device 618.

The arrangement of the nozzle 610, second energy source 614, imaging device 616, and material removal device 618 can also be varied as desired. In some embodiments, for example, some or all of these components are located on the same side of the first printer assembly 302 (e.g., proximate to the post-print zone 336 or the pre-print zone 322), such that these components operate while the first printer assembly 302 is moving in the same direction.

Optionally, some or all of the components of the error correction assembly (e.g., the imaging device 616 and/or the material removal device 618) can be separate from the first printer assembly 302 and/or the second printer assembly, rather than being integrated into and/or otherwise carried by the first printer assembly 302 and/or the second printer assembly. In such embodiments, the error correction assembly can be operated independently of the first printer assembly 302 and/or the second printer assembly. When an error is detected, the operation of the first printer assembly 302 and/or the second printer assembly can be paused, and the error correction assembly can be directed to the location of the error. The error correction assembly can remain at that location until the correction is completed and/or until a predetermined time period has elapsed. If multiple errors are detected, the error correction assembly can be sequentially moved to each error location, until all the errors in the current portion of the object 602 have been corrected. The first printer assembly 302 and/or the second printer assembly can then resume operating to print the next portion of the object 602.

Moreover, the system 600 may use other types of error correction techniques, in addition or alternatively to using the material removal device 618. For instance, as discussed elsewhere herein, other types of error correction techniques that may be used include reprinting a portion of the object 602 where material was omitted or insufficiently cured, adjusting a digital representation of the object 602 to compensate for the error (e.g., changing the geometry and/or energy parameters of subsequent object layers), adjusting a digital representation of other objects that are printed concurrently with the object 602 to compensate for the error (e.g., changing the geometry and/or energy parameters for the other objects), adjusting an alignment of the first printer assembly 302 and/or the second printer assembly, etc. Optionally, an error correction technique may include discontinuing printing of the object 602 and/or other objects proximate to the object 602 if the error is too severe to be corrected.

FIG. 7A is a flow diagram illustrating a method 700a for manufacturing an object, in accordance with embodiments of the present technology. The method 700a can be performed by any embodiment of the systems and devices described herein, such as the system 600 of FIGS. 6A-6E. In some embodiments, some or all of the processes of the method 700a are implemented as computer-readable instructions (e.g., program code) that are configured to be executed by one or more processors of a computing device, such as the controller 620 of FIGS. 6A-6E.

The method 700a can begin at block 702 with forming a first object portion from a first material. The first object portion can be formed using a first additive manufacturing process implemented by a first printer assembly (e.g., the first printer assembly 302 of FIGS. 6A-6E). The first object portion can be an entire layer, a portion of a layer, an entire cross-section, a portion of a cross-section, or any other part of the geometry of the additively manufactured object. The first object portion can be formed using any suitable additive manufacturing technique described herein. For example, the first object portion can be formed by instructing the first printer assembly to apply energy to a layer of the first material according to a digital representation of a target geometry for the first object portion. The energy can selectively cure the first material, thus forming a cured material layer onto a build platform or onto a previously formed portion of the object, as described herein.

At block 704, the method 700a can include forming a second object portion from a second material. The second object portion can be formed using a second additive manufacturing assembly (e.g., the second printer assembly including the nozzle 610 and second energy source 614 of FIGS. 6A-6E). The second object portion can be an entire layer, a portion of a layer, an entire cross-section, a portion of a cross-section, or any other part of the geometry of the additively manufactured object. The second object portion can be formed using any suitable additive manufacturing technique described herein. For example, the second object portion can be formed by instructing the second printer assembly to selectively deposit the second material at one or more locations corresponding to the target geometry for the second object portion.

At block 706, the method 700a can include obtaining sensor data of the second object portion. In some embodiments, the sensor data includes image data, which can be obtained using one or more imaging devices (e.g., the imaging device 616 of FIGS. 6A-6E), and can include 2D and/or 3D data representing the actual geometry of the second object portion. The image data can include one or more images of the second object portion in any suitable wavelength, such as infrared wavelengths, visible wavelengths, ultraviolet wavelengths, or combinations thereof. Alternatively or in combination, the process of block 706 can include obtaining other types of sensor data, as disclosed elsewhere herein. For instance, the sensor data obtained in block 706 can include sensor data indicative of the response of the second object portion to mechanical perturbations, and/or sensor data representing the velocity, acceleration, force, and/or torque of a movable component of the printer assembly.

At block 708, the method 700a can continue with determining whether an error is present in the second object portion, based on the sensor data. For example, image data can be analyzed using computer vision algorithms, machine learning algorithms, and/or other suitable techniques to detect the presence of errors. In embodiments where the image data shows both the first object portion and the second object portion, the process of block 708 can involve identifying the second object portion in the image data, e.g., based on color and/or other optical characteristics of the second object portion that differ from the optical characteristics of the first object portion. Optionally, the process of block 708 can include processing the image data so that only the second object portion is visible (e.g., by extracting pixels corresponding to the second object portion from the image data and/or by deleting pixels corresponding the first object portion from the image data).

In some embodiments, the process of block 708 involves comparing the image data of the second object portion to a digital representation of the second object portion. The digital representation can be a 3D model and/or a 2D image of the second object portion depicting a target geometry for the second object portion. The comparison can be used to identify any differences between the actual geometry of the second object portion and the target geometry that are indicative of an error (e.g., missing material or excess material). Optionally, the process of block 708 can further include identifying the coordinate location of the error within the second object portion.

At block 710, if no error is present, the method 700a can proceed to block 714 to apply energy to the cure the second object portion (e.g., using the second energy source 614 of FIGS. 6A-6E). If an error is determined to be present (e.g., the second object portion includes material at an undesired location), the method 700a can continue to block 712 to correct the error by removing at least a region of the second object portion. The removed region can be only the region containing the error, can include other regions proximate to the region containing the error (e.g., within 1 mm, 2 mm, 3 mm, 4 mm, 5 mm, or 1 cm of the location of the error), or can be the entire second object portion. The region of the second object portion can be corrected using any suitable material removal technique described herein. In some embodiments, for example, the process of block 712 involves instructing a material removal device (e.g., the material removal device 618 of FIGS. 6A-6E) to correct the error by suctioning some or all of the second material forming the second object portion.

Once the error has been corrected, the method 700a can proceed to block 714 to apply energy to cure the remaining region of the second object portion. If the entirety of the second object portion was removed in block 712, the method 700a can instead repeat the processes of blocks 704-710 to reform the second object portion and check for errors. Once the second object portion has been successfully formed and cured, the method 700a can then proceed with forming the next portion of the object, such as another first object portion from the first material or another second object portion from the second material. The method 700a can then be repeated until the entire object has been formed.

The method 700a can be modified in many different ways. For example, the order of the processes shown in FIG. 7A can be changed, e.g., the processes of blocks 704-714 can be performed before the process of block 702, such that the second object portion is formed before the first object portion. As another example, the method 700a can include additional processes not shown in FIG. 7A. In some embodiments, depending on the type of error, the method 700a can correct the error using other processes besides the process of block 712. For instance, if the error involves missing material at a particular location of the second object portion, the method 700a can correct the error by operating the second printer assembly to redeposit the second material to that location. Additionally, the method 700a can involve confirming that the error was successfully corrected (e.g., based on additional image data and/or other sensor data) before continuing to block 714 to cure the second object portion.

The method 700a can be combined with any of the other methods described herein. In some embodiments, for example, the method 700a can be combined with the method 400a of FIG. 4A and/or the method 400b of FIG. 4B in order to detect and/or correct errors in the first object portion. In such embodiments, some or all of the processes of the method 400a and/or the method 400b can be performed after forming the first object portion in block 702, and concurrently or sequentially with the processes of blocks 704-714.

FIG. 7B is a flow diagram illustrating a method 700b for manufacturing an object, in accordance with embodiments of the present technology. The method 700b can be performed by any embodiment of the systems and devices described herein, such as the system 600 of FIGS. 6A-6E. In some embodiments, some or all of the processes of the method 700b are implemented as computer-readable instructions (e.g., program code) that are configured to be executed by one or more processors of a computing device, such as the controller 620 of FIGS. 6A-6E.

The method 700b can include forming a first object portion from a first material (block 712), forming a second object portion from a second material (block 714), obtaining sensor data of the second object portion (block 716), and determining whether an error is present in the second object portion (block 718). The processes of blocks 712, 714, 716, and 718 may be identical or generally similar to the processes of blocks 702, 704, 706, and 708 of the method 700a of FIG. 7A.

At block 720, if no error is present, the method 700b can proceed to block 726 to apply energy to cure the second object portion (e.g., using the second energy sources of FIGS. 6A-6E). If an error is determined to be present, the method 700b can instead continue to block 722 with determining whether the error is correctable. The determination can be based on the size of the error (e.g., errors that are too large may be considered uncorrectable), the location of the error (e.g., errors that occur at critical locations of the object may be considered uncorrectable), the type of error (e.g., whether the error involves omission of material, deposition of excess material, insufficient curing of material, overcuring of material), and/or other relevant considerations. In some embodiments, the error is considered correctable if the additive manufacturing system includes error correction capabilities suitable for addressing the error (e.g., a material removal device for removing incorrectly deposited material), and is considered uncorrectable if the additive manufacturing system does not include error correction capabilities suitable for addressing the error and/or it is determined that manual intervention by a human operator is needed to correct the error.

If the error is correctable, the method 700b can continue to block 724 to correct the error. The error may be corrected in various ways, such as by removing a region of the object portion to compensate for incorrectly deposited material (e.g., as previously described with respect to block 712 of the method 700a of FIG. 7A), depositing additional material to compensate for omission of material, adjusting the digital representation of the object (e.g., changing the geometry and/or energy parameters for the current object slice or for subsequent object slices), adjusting the digital representation of other objects proximate to the object, or suitable combinations thereof. The error correction technique used may depend on the size, location, and/or type of error that occurred, as well as the available error correction capabilities of the additive manufacturing system. Once the error has been corrected, the method 700b can continue to block 726 to apply energy to cure the second object portion, and then with forming the next portion of the object, such as another first object portion from the first material or another second object portion from the second material. The method 700b can then be repeated until the entire object has been formed.

If the error is not correctable, the method 700b can instead continue to block 728 to terminate additive manufacturing of the object containing the error, while continuing additive manufacturing of other objects that are being concurrently fabricated on the same build platform. In some embodiments, it may be advantageous to continue printing other objects that are not affected by the error to maintain high manufacturing throughput, while selectively terminating the printing of the object having the error to conserve materials that would be consumed in attempting to print that object and/or to reduce the likelihood of the error affecting the printing of the other objects. Optionally, the process of block 728 can also include terminating the additive manufacturing of one or more objects that are proximate to the object affected by the error (e.g., objects within the same zone or quadrant of the build platform as the affected object), while continuing the additive manufacturing of one or more objects that are sufficiently far away from the affected object (e.g., objects in a different zone or quadrant of the build platform as the affected object).

The process of block 728 can be implemented in various ways. For example, the additive manufacturing of one or more objects may be terminated by removing those objects from fabrication instructions (e.g., the file containing the object slices or other digital representation) that are used to control the additive manufacturing system. The removal can be performed via a masking process, e.g., as discussed further below in connection with FIGS. 8A-9B. As another example, in embodiments where the additive manufacturing system includes multiple energy sources, with each energy source configured to apply energy to a respective zone of the build platform to fabricate one or more objects within that zone, the additive manufacturing of the object affected by the error and/or objects proximate to the affected object may be terminated by deactivating the energy source associated with the zone of the affected object. Subsequently, the processes of the method 700b can be repeated for the remaining objects on the build platform to complete the additive manufacturing of the remaining objects.

The method 700b can be modified in many different ways. For example, the order of the processes shown in FIG. 7B can be changed, e.g., the processes of blocks 714-726 can be performed before the process of block 712, such that the second object portion is formed before the first object portion. As another example, the method 700b can include additional processes not shown in FIG. 7B. In some embodiments, the method 700b involves confirming that the error was successfully corrected (e.g., based on additional sensor data) before continuing to block 726 to cure the second object portion.

The method 700b can be combined with any of the other methods described herein. In some embodiments, for example, the method 700b can be combined with the method 400a of FIG. 4A and/or the method 400b of FIG. 4B in order to detect and/or correct errors in the first object portion. In such embodiments, some or all of the processes of the method 400a and/or the method 400b can be performed after forming the first object portion in block 712, and concurrently or sequentially with the processes of blocks 714-726.

The additive manufacturing systems, devices, and methods of the present technology can be used to fabricate a plurality of objects, such as two, three, four, five, ten, twenty, fifty, or more objects. The objects can be formed concurrently on the same build platform in the course of a single additive manufacturing operation. The objects can differ from each other with respect to geometry (e.g., shape, size) and material composition (e.g., the types and locations of materials used). For instance, any of the objects can be fabricated from a single curable material (e.g., as described with respect to FIGS. 2-4B) or from multiple curable materials (e.g., as described with respect to FIGS. 5A-7B). The present technology can be used to detect and correct errors that may occur during fabrication of any individual object of the plurality of objects. For instance, the techniques described herein with respect to FIGS. 1A-7B can be used to identify and remove any erroneously deposited material in any of the plurality of objects, as well as to identify and reapply missing material to any of the plurality of objects.

In some situations, it may be difficult or impossible to correct certain types of errors. Accordingly, it can be advantageous to terminate the printing of the affected object to conserve materials that would be consumed in attempting to print that object, as well as reduce the likelihood of the error affecting the printing of the other objects on the build platform. In some embodiments, it is desirable to continue printing the other objects, rather than terminating and restarting the entire printing operation, to avoid wasting material and time that has already been expended in printing the other objects.

FIG. 8A is a flow diagram illustrating a method 800a for manufacturing a plurality of objects, in accordance with embodiments of the present technology. The method 800a can be used to selectively terminate printing of an object that contains an error, while continuing to print the remaining objects that do not contain the error. The method 800a can be performed by any embodiment of the systems and devices described herein, such as the system 100A of FIG. 1A, the system 100B of FIG. 1B, the system 100C of FIG. 1C, the system 300 of FIGS. 3A-3C, or the system 600 of FIGS. 6A-6E. In some embodiments, some or all of the processes of the method 800a are implemented as computer-readable instructions (e.g., program code) that are configured to be executed by one or more processors of a computing device (e.g., the controller 106 of FIG. 1A, the controller 334 of FIGS. 3A-3C, or the controller 620 of FIGS. 6A-6E). Moreover, the method 800a can be combined with any of the other methods described herein (e.g., the method 400a of FIG. 4A, the method 400b of FIG. 4B, the method 700a of FIG. 7A, and/or the method 700b of FIG. 7B).

The method 800a can begin at block 802 with receiving a digital representation of a plurality of objects to be fabricated. The digital representation can represent a single batch of objects that are intended to be fabricated during the same additive manufacturing operation and/or on a single build platform. For example, the objects can be a set of appliances to be used to treat a single patient in accordance with a prescribed treatment plan. The digital representation can be any suitable data set, file, etc., that represents the target geometry for each of the objects. For instance, the digital representation can be or include a 3D model depicting the 3D shape of each object, and/or a set of 2D images depicting the 2D geometry of a plurality of individual layers for each object. In some embodiments, the digital representation includes a series of slices for additive manufacturing of the objects from a plurality of sequential layers.

At block 804, the method 800a can continue with forming a portion of each object based on the digital representation. Each object portion can be a layer or a part of a layer, cross-section or a part of a cross-section, or other suitable part of the corresponding object. The object portions can be formed using any suitable additive manufacturing process described herein. For instance, each object portion can be formed by using one or more printer assemblies to deposit one or more materials at the locations indicated by the digital representations.

FIG. 9A is a partially schematic illustration of a digital representation 900 for use in manufacturing a portion of each of a plurality of objects, in accordance with embodiments of the present technology. The digital representation 900 can be any suitable data set that provides information regarding the locations and geometries of the objects. In some embodiments, the digital representation is an image having any suitable image file type, such as a black and white bitmap file. The layout of the objects in the digital representation 900 can correspond to the desired layout of the objects on the build platform. As shown in FIG. 9A, the digital representation 900 depicts the target geometry of an individual portion (e.g., layer) of each object, such as a first object 902a and a second object 902b. The locations and values of each pixel in the digital representation 900 can be used to identify where material should be placed to form that object portion. For instance, in the illustrated embodiment, non-white (e.g., black) pixels represent locations where the material should be placed, while white pixels represent locations where the material should not be placed. In other embodiments, this representation can be reversed, with white pixels representing locations where the material should be placed, and non-white pixels representing locations where the material should not be placed. Optionally, the pixels can be grayscale pixels rather than black and white pixels, with the grayscale value of each pixel representing the energy parameters (e.g., exposure time and/or energy intensity) to be applied to the material at that pixel location. The digital representation 900 can be part of a series of digital representations (e.g., a series of object slices) that collectively depict the entire target geometry for each object and thus provide instructions for sequentially building up each object in a layer-by-layer manner.

Referring again to FIG. 8A, at block 806, the method 800a can include making a determination about the presence and/or absence of an error in the formed portion of at least one object. The determination of the presence of the error can be performed using any of the techniques described herein. For example, the process of block 806 can include obtaining image data of each of the object portions using one or more imaging devices, such as a camera, scanner, etc. The image data can be compared to the digital representation of the object portions to determine whether there are any discrepancies between the actual geometry and the target geometry for each object portion, such as excess material, missing material, etc. Alternatively or in combination, other types of sensor data can be used to determine whether an error is present, such as sensor data indicative of the response of the second object portion to mechanical perturbations, and/or sensor data representing the velocity, acceleration, force, and/or torque of a movable component of the printer assembly.

At block 808, the method 800a can modify the digital representation of the plurality of objects to remove the object that is affected by the error. The modification can include masking, extracting, or deleting the part of the digital representation that depicts the affected object. The modification can be selectively applied so that parts of the digital representation corresponding to other objects are not affected.

For example, referring again to FIG. 9A, each object in the digital representation 900 can be associated with a corresponding boundary, such as a first boundary 904a for the first object 902a, and a second boundary 904b for the second object 902b. The boundary can be a set of coordinates representing the locations associated with a particular object in the layout. In some embodiments, the boundary is implemented as metadata associated with the digital representation 900. Accordingly, each object in the layout can be mapped to a corresponding boundary, such that the location of each object can be determined from the digital representation 900, based on the boundary. In the illustrated embodiment, the boundary is larger than the actual geometry of the corresponding object. For instance, the area within the boundary can be sufficiently large so as to encompass the maximum extent of each portion of the object in the layout. In other embodiments, however, the boundary can be the same size as the actual geometry of the corresponding object.

If an error is detected in the first object 902a, the digital representation 900 can be modified to remove the first object 902a by modifying some or all of the pixels within the first boundary 904a. For example, FIG. 9B illustrates the digital representation 900 after the first object 902a has been removed. In some embodiments, a digital mask is applied to some or all of the pixels contained by the first boundary 904a to revert those pixels to a baseline value. In the illustrated embodiment, the mask has converted the pixels within the first boundary 904a to white pixels, thus indicating that material should not be deposited at any of the locations delineated by the first boundary 904a. Moreover, in embodiments where the digital representation 900 is part of a series of digital representations that collectively depict the entire target geometry for the objects, the mask can also be applied to the pixels within the first boundary 904a in some or all of the other digital representations (e.g., all of the digital representations representing subsequent layers of the first object 902a). As can be seen in FIG. 9B, the pixels corresponding to the other objects (e.g., the second object 902b) can remain unaffected.

Referring again to FIG. 8A, at block 810, the method 800a can continue with forming a portion of each remaining object based on the modified digital representation. The object portions formed in block 810 can be the next layer, cross-section, etc., of each remaining object. Because the object containing the error has been removed from the digital representation, the process of block 810 can be performed without forming any additional portions of that object, thus selectively terminating the printing of the object while continuing the printing of the other objects. Accordingly, many of the objects can still be completed, even if there are errors affecting other objects on the same layout.

The method 800a can be modified in many different ways. For example, the process of block 808 can alternatively or additionally include other types of modifications. For instance, rather than removing the object affected by the error, the digital representation can be modified to change the geometry (e.g., size and/or shape) of the affected object and/or to change the energy parameters (e.g., grayscale values) for the affected object. Such modifications can be made to the entire object, or only to the particular region of the object affected by the error. As another example, the modifications can include modifications to other objects in the digital representation, e.g., objects that are proximate to the affected object can be removed or otherwise modified if the detected error might also affect the fabrication of those objects. Any of the modifications described herein may be made to the digital representation corresponding to the current layer of the objects, to one or more digital representations corresponding to one or more subsequent layers of the objects, or suitable combinations thereof.

Moreover, the method 800a can include additional processes not shown in FIG. 8A. In some embodiments, if an error is detected in block 806, the method 800a can assess whether the error is correctable, before proceeding to block 808. The assessment can be made by attempting to correct the error, e.g., using the techniques described in connection with FIGS. 1A-7B. Alternatively or in combination, the method 800a can attempt to correct the error by using an algorithm to generate a corrective shape for the object portion, and then printing the corrective shape. The appropriate shape can be determined based on the type of error observed, and can be generated using a simulation, rule-based algorithm, machine learning algorithm, or any other suitable approach. If the error is successfully corrected, the printing of the object can continue, without modifying the digital representation. If the error is not successfully corrected after one or more attempts, the method 800a can proceed to block 808 to terminate printing of the object by removing the object from the digital representation, as described herein. Alternatively, the assessment can be made without actually attempting to correct the error. For instance, certain types of errors can automatically be considered too severe to correct, depending on characteristics such as size, location, type, etc., and the method 800a can proceed to block 808 to terminate printing of the object if such an error is detected.

Furthermore, the boundaries illustrated in the embodiment of FIGS. 9A and 9B can be varied as desired. For instance, although the boundaries are depicted as having a square shape, in other embodiments, the boundaries can be defined with any suitable geometry (e.g., rectangular, circular, oval, polygonal, U-shaped, matching the shape of the perimeter of the object, etc.). In some embodiments, the boundaries are defined to encompass multiple objects (e.g., multiple objects within the same zone or quadrant of the build platform), such that the modifications described herein may be applied to multiple objects concurrently. This approach may be advantageous, for example, if an error detected in a single object has a high likelihood of affecting the fabrication of other nearby objects. As another example, boundaries may be defined for smaller regions of an individual object to allow modifications to be made to each of the regions independently. Optionally, a single digital representation may include multiple types of boundaries (e.g., boundaries encompassing multiple objects, boundaries encompassing a single object, and/or boundaries encompassing smaller regions of a single object), which can provide greater flexibility for different types of modifications to compensate for errors during the additive manufacturing process.

FIG. 8B is a flow diagram illustrating a method 800b for manufacturing a plurality of objects, in accordance with embodiments of the present technology. The method 800b can be used to dynamically modify the digital representation of one or more objects to compensate for any detected errors. The method 800b can be performed by any embodiment of the systems and devices described herein, such as the system 100A of FIG. 1A, the system 100B of FIG. 1B, the system 100C of FIG. 1C, the system 300 of FIGS. 3A-3C, or the system 600 of FIGS. 6A-6E. In some embodiments, some or all of the processes of the method 800b are implemented as computer-readable instructions (e.g., program code) that are configured to be executed by one or more processors of a computing device (e.g., the controller 106 of FIG. 1, the controller 334 of FIGS. 3A-3C, or the controller 620 of FIGS. 6A-6E). Moreover, the method 800b can be combined with any of the other methods described herein (e.g., the method 400a of FIG. 4A, the method 400b of FIG. 4B, the method 700a of FIG. 7A, and/or the method 700b of FIG. 7B).

The method 800b can include receiving a digital representation of a plurality of objects to be fabricated (block 812), forming a portion of each object based on the digital representation (block 814), and making a determination about the presence and/or absence of an error in the formed portion of at least one object (block 816). The processes of blocks 812, 814, and 816 may be identical or generally similar to the processes of blocks 802, 804, and 806 of the method 800a of FIG. 8A.

At block 818, the method 800b can include determining whether the error is correctable. The determination can be based on the size of the error (e.g., errors that are too large may be considered uncorrectable), the location of the error (e.g., errors that occur at critical locations of the object may be considered uncorrectable), the type of error (e.g., whether the error involves omission of material, deposition of excess material, insufficient curing of material, overcuring of material), and/or other relevant considerations. In some embodiments, the error is considered correctable if the additive manufacturing system includes error correction capabilities suitable for addressing the error (e.g., a material removal device for removing incorrectly deposited material), and is considered uncorrectable if the additive manufacturing system does not include error correction capabilities suitable for addressing the error and/or it is determined that manual intervention by a human operator is needed to correct the error.

If the error is correctable, the method 800b can continue to block 820 with modifying the digital representation to correct the error. As previously discussed (e.g., in connection with FIGS. 9A and 9B), the digital representation of the objects can include information regarding the location and geometry of each object, and in some instances, the location and geometry of smaller regions within an individual object, thus allowing modifications to be made to a particular object, to a particular region within an object, to a particular group of objects, or any suitable combination thereof. In some embodiments, the modification to the digital representation includes one or more of the following: changing a geometry of the formed portion of the object affected by the error (e.g., the size and/or shape of the current object slice), changing a geometry of a subsequent portion of the affected object (e.g., the size and/or shape of a subsequent object slice), changing energy parameters for the formed portion of the affected object (e.g., the exposure time, energy intensity, and/or grayscale values for the current object slice), changing energy parameters for a subsequent portion of the affected object (e.g., the exposure time, energy intensity, and/or grayscale values for a subsequent object slice), changing a geometry of the formed portion of another object (e.g., another object proximate to the affected object) changing a geometry of a subsequent portion of another object, changing energy parameters for the formed portion of another object, and/or changing energy parameters for a subsequent portion of another object. Subsequently, the method 800b can proceed to block 822 with forming a portion of each object based on the modified digital representation, including the object with the error.

If the error is not correctable, the method 800b can instead proceed to block 824 to modify the digital representation to remove the object that is affected by the error, and then to block 826 to form a portion of each remaining object based on the modified digital representation. The processes of blocks 824 and 826 may be identical or generally similar to the processes of blocks 808 and 810 of the method 800a of FIG. 8A.

The method 800b can be modified in many different ways. For example, the method 800b can include other types of corrections besides modifying the digital representation, such as generating instructions for a material removal device to remove a region of the formed portion of the object containing the error. The type of correction process to be used can be selected based on the size, location, and/or type of error, as well as the error correction capabilities of the additive manufacturing system.

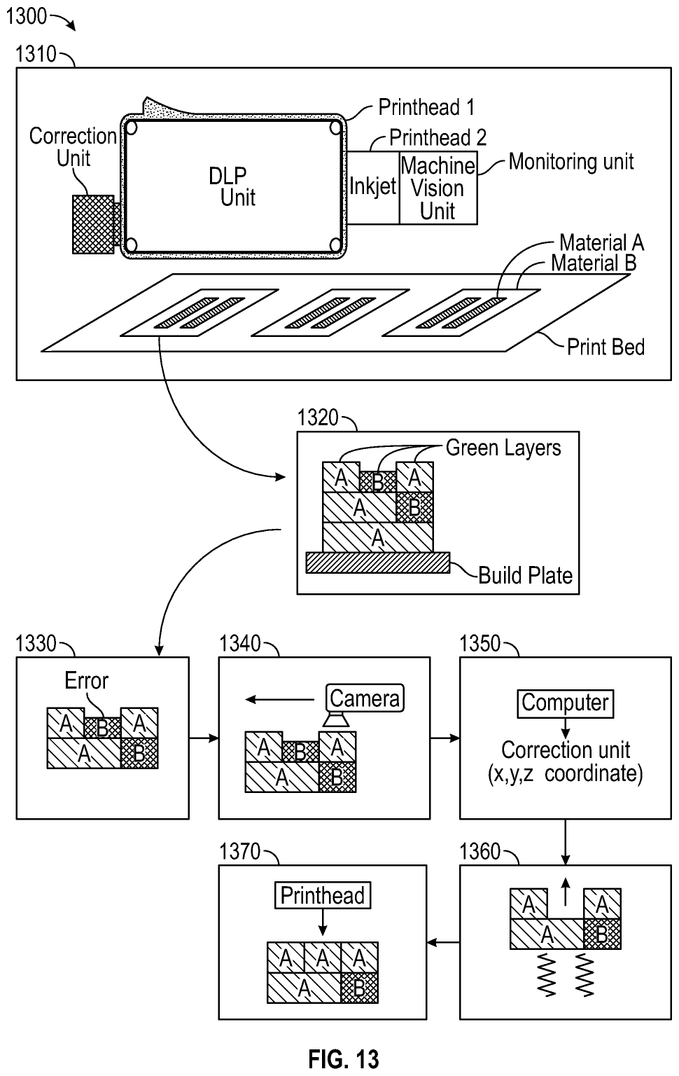

FIG. 13 illustrates elements of a process 1300 for correcting print errors in additive manufacturing system(s), in accordance with embodiments of the present technology. The process 1300 and/or any operations therein, may be performed by any of the machinery, hardware, and/or software described herein. At an operation 1310, a print system is shown additively manufacturing curable material into 3D printed items. The print system includes one or more printheads (e.g., a DLP printhead and an inkjet printhead), a print bed, curable material (shown as Material A and Material B), a monitoring unit (e.g., a machine vision unit), and a correction unit (e.g., a material removal mechanism). Material is deposited onto the print bed through one or more material delivery systems and is cured using the one or more printheads. At an operation 1320, a zoomed view shows green layers of uncured material and different cured materials deposited and fused together using light, temperature, and/or other curing radiation and/or other curing mechanisms. Cured and/or uncured materials reside on build plate. At operation 1330, there is illustrated a layer that is incorrectly deposited (e.g., layer B). At operation 1340, a camera of monitoring unit can capture one or more images of the incorrect deposition during travel of a printhead. At an operation 1350, a computer of the monitoring unit provides an appropriate position of error correction to correction unit. Correction unit can be directed to the appropriate position and performs corrections. At operation 1360, correction unit can suction out extra material associated with print errors; the system can be agitated to lower viscosity or modify other properties of uncured material. At operation 1370, the printhead performs corrective action on the same layer in pixel by pixel or voxel by voxel fashion.

### II. Dental Appliances and Associated Methods

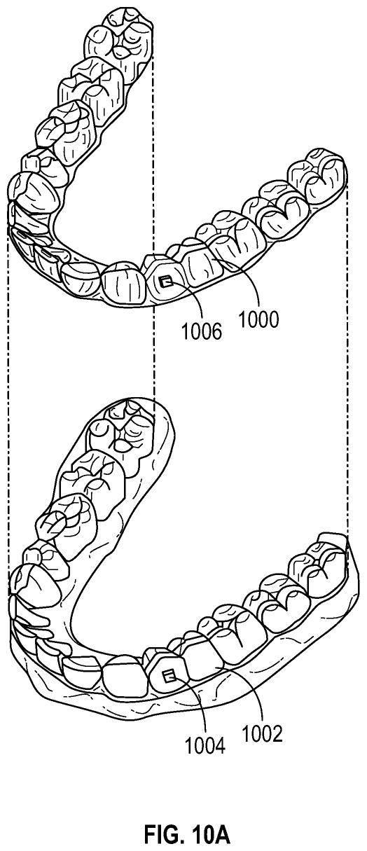

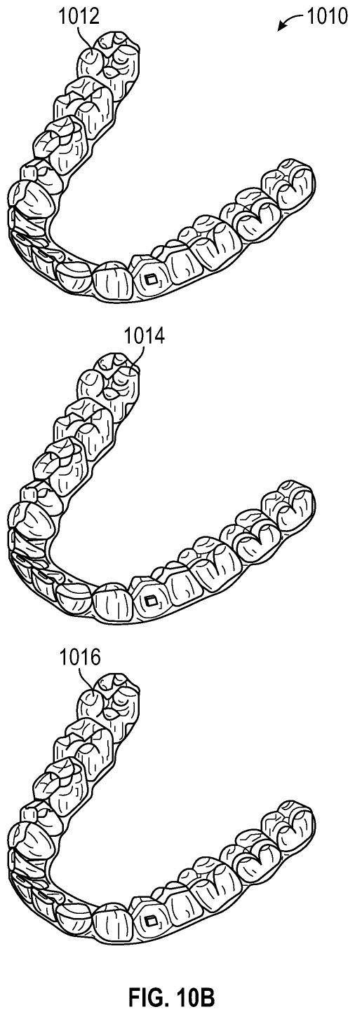

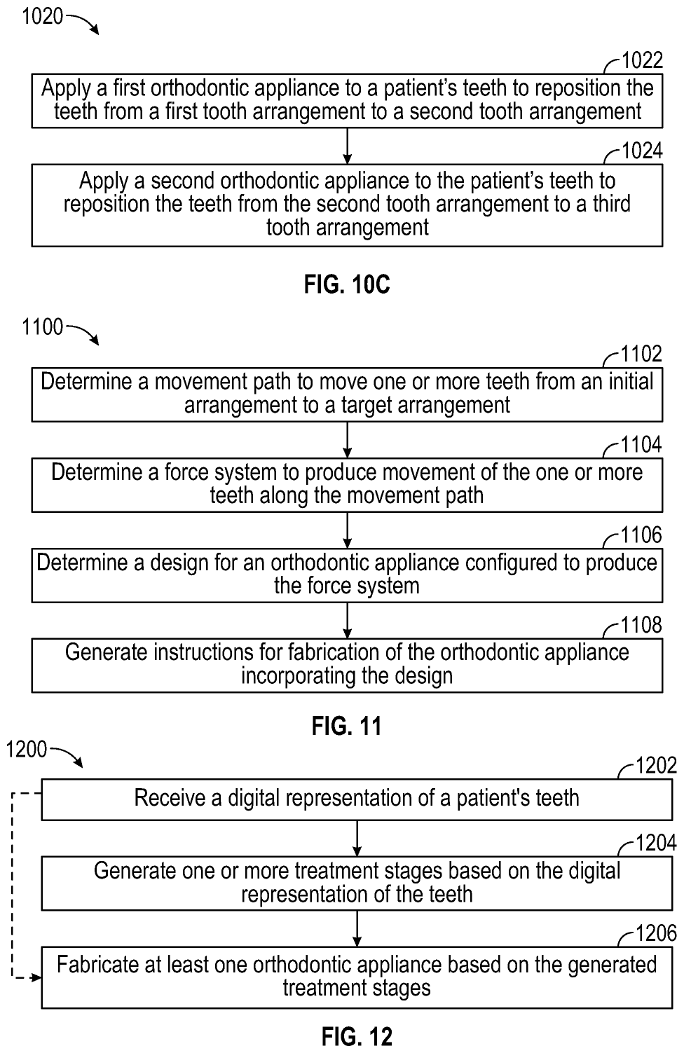

FIG. 10A illustrates a representative example of a tooth repositioning appliance 1000 configured in accordance with embodiments of the present technology. The appliance 1000 can be manufactured using any of the systems, methods, and devices described herein. The appliance 1000 (also referred to herein as an “aligner”) can be worn by a patient in order to achieve an incremental repositioning of individual teeth 1002 in the jaw. The appliance 1000 can include a shell (e.g., a continuous polymeric shell or a segmented shell) having teeth-receiving cavities that receive and resiliently reposition the teeth. The appliance 1000 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 1000 can fit over all teeth present in an upper or lower jaw, or less than all of the teeth. The appliance 1000 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 1000 can be a generic appliance configured to receive the teeth, but not necessarily shaped to match the topography of the patient's teeth. In some cases, only certain teeth received by the appliance 1000 are repositioned by the appliance 1000 while other teeth can provide a base or anchor region for holding the appliance 1000 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 1000 in place over the teeth. In some cases, however, it may be desirable or necessary to provide individual attachments 1004 or other anchoring elements on teeth 1002 with corresponding receptacles 1006 or apertures in the appliance 1000 so that the appliance 1000 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 10B illustrates a tooth repositioning system 1010 including a plurality of appliances 1012, 1014, 1016, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1010 can include a first appliance 1012 corresponding to an initial tooth arrangement, one or more intermediate appliances 1014 corresponding to one or more intermediate arrangements, and a final appliance 1016 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 10C illustrates a method 1020 of orthodontic treatment using a plurality of appliances, in accordance with embodiments of the present technology. The method 1020 can be practiced using any of the appliances or appliance sets described herein. In block 1022, a first orthodontic appliance is applied to a patient's teeth in order to reposition the teeth from a first tooth arrangement to a second tooth arrangement. In block 1024, a second orthodontic appliance is applied to the patient's teeth in order to reposition the teeth from the second tooth arrangement to a third tooth arrangement. The method 1020 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

FIG. 11 illustrates a method 1100 for designing an orthodontic appliance, in accordance with embodiments of the present technology. The method 1100 can be applied to any embodiment of the orthodontic appliances described herein. Some or all of the steps of the method 1100 can be performed by any suitable data processing system or device, e.g., one or more processors configured with suitable instructions.

In block 1102, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1104, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1104 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1106, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1108, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1100 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1100 may be performed with any suitable fabrication system or device, such as the embodiments described herein. Some of the steps may be optional, e.g., the process of block 1104 can be omitted, such that the orthodontic appliance is designed based on the desired tooth movements and/or determined tooth movement path, rather than based on a force system. Moreover, the order of the steps can be varied as desired.

FIG. 12 illustrates a method 1200 for digitally planning an orthodontic treatment and/or design or fabrication of an appliance, in accordance with embodiments. The method 1200 can be applied to any of the treatment procedures described herein and can be performed by any suitable data processing system.

In block 1202 a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1204, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1206, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 12, design and/or fabrication of an orthodontic appliance, and perhaps a particular orthodontic treatment, may include use of a representation of the patient's teeth (e.g., including receiving a digital representation of the patient's teeth (block 1202)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment fabrication templates, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled, “Flexible 3D Printed Orthodontic Device,” filed Feb. 24, 2021; U.S. application Ser. No. 16/366,686, entitled, “Dental Attachment Placement Structure,” filed Mar. 27, 2019; U.S. application Ser. No. 15/674,662, entitled, “Devices and Systems for Creation of Attachments,” filed Aug. 11, 2017; U.S. Pat. No. 11,103,330, entitled, “Dental Attachment Placement Structure,” filed Jun. 14, 2017; U.S. application Ser. No. 14/963,527, entitled, “Dental Attachment Placement Structure,” filed Dec. 9, 2015; U.S. application Ser. No. 14/939,246, entitled, “Dental Attachment Placement Structure,” filed Nov. 12, 2015; U.S. application Ser. No. 14/939,252, entitled, “Dental Attachment Formation Structures,” filed Nov. 12, 2015; and U.S. Pat. No. 9,700,385, entitled, “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled, “Releasable Palatal Expanders,” filed Apr. 10, 2019; U.S. application Ser. No. 16/022,552, entitled, “Devices, Systems, and Methods for Dental Arch Expansion,” filed Jun. 28, 2018; U.S. Pat. No. 11,045,283, entitled, “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled, “Methods and Apparatuses for Customizing a Rapid Palatal Expander,” filed Dec. 4, 2017; and U.S. Pat. No. 7,192,273, entitled, “System and Method for Palatal Expansion,” filed Aug. 7, 2003; all of which are incorporated by reference herein in their entirety.

### Examples

The following examples are included to further describe some aspects of the present technology, and should not be used to limit the scope of the technology.

Example 1. A system comprising:
a printer assembly configured to perform an additive manufacturing process with a curable material;
at least one sensor;
a material removal device;
a processor operably coupled to the printer assembly, the at least one sensor, and the material removal device; and
a memory operably coupled to the processor and storing instructions that, when executed by the processor, cause the system to perform operations comprising:
   forming an object portion from the curable material using the printer assembly;
   obtaining sensor data of the object portion using the at least one sensor;
   determining whether an error is present in the object portion based on the sensor data; and
   in response to a determination that the error is present in the object portion, removing a region of the object portion containing the error using the material removal device.

Example 2. The system of Example 1, wherein the printer assembly comprises:
a nozzle configured to form the object portion by depositing one or more droplets of the curable material, and
an energy source configured to apply energy to cure the curable material.

Example 3. The system of Example 2, wherein the operations further comprise applying the energy to cure a remaining region of the object portion, after removing the region of the object portion.

Example 4. The system of Example 2 or 3, wherein the material removal device comprises a vacuum mechanism configured to remove the region of the object portion via suction.

Example 5. The system of any one of Examples 2 to 4, wherein the material removal device comprises a charged surface configured to remove the region of the object portion via electrostatic interactions with the curable material.

Example 6. The system of any one of Examples 2 to 5, further comprising a heat source configured to heat the curable material.

Example 7. The system of any one of Examples 2 to 6, further comprising an agitator configured to apply mechanical perturbations to the curable material.

Example 8. The system of any one of Examples 2 to 7, further comprising a second printer assembly configured to perform a second additive manufacturing process with a second curable material.

Example 9. The system of Example 8, wherein the additive manufacturing process comprises material jetting, and the second additive manufacturing process comprises stereolithography or digital light processing.

Example 10. The system of Example 8 or 9, wherein the second printer assembly comprises:
a carrier film configured to support a layer of the second curable material, and
a second energy source configured to apply second energy to cure the second curable material.

Example 11. The system of any one of Examples 8 to 10, wherein the operations further comprise forming a second object portion from the second curable material using the second printer assembly, wherein the object portion is proximate to the second object portion.

Example 12. The system of any one of Examples 1 to 11, wherein the at least one sensor comprises an imaging device and the sensor data comprises image data generated by the imaging device.

Example 13. The system of Example 12, wherein the imaging device is configured to selectively image the object portion.

Example 14. The system of Example 12 or 13, wherein the image data shows the object portion and a second object portion, and the operations further comprise identifying a location of the object portion in the image data.

Example 15. The system of any one of Examples 1 to 14, wherein the at least one sensor is configured to measure one or more of a velocity, an acceleration, a force, or a torque of a movable component of the printer assembly.

Example 16. The system of any one of Examples 1 to 15, wherein the printer assembly comprises:
a carrier film configured to support a layer of the curable material, and
an energy source configured to form the object portion by applying energy to cure the curable material.

Example 17. The system of Example 16, wherein the operations further comprise applying the energy to cure the object portion, before determining whether the error is present.

Example 18. The system of Example 15 or 16, wherein the material removal device comprises a laser configured to remove the region of the object via ablation.

Example 19. The system of any one of Examples 1 to 18, wherein determining whether the error is present comprises:
receiving a digital representation of a target geometry of the object portion,
determining an actual geometry of the object portion, based on the sensor data, and
identifying whether there are any differences between the actual geometry and the target geometry.

Example 20. The system of Example 19, wherein the operations further comprise: identifying a location of the error in the object portion, and selectively targeting the material removal device to the location of the error.

Example 21. The system of any one of Examples 1 to 20, wherein the region of the object portion that is removed is less than the entire object portion.

Example 22. The system of any one of Examples 1 to 21, wherein the region of the object portion that is removed is the entire object portion.

Example 23. The system of any one of Examples 1 to 22, wherein the printer assembly is configured to perform the additive manufacturing process to fabricate a plurality of objects concurrently, and wherein the operations further comprise:
determining whether the error is correctable,
in response to a determination that the error is correctable, removing the region of the object portion containing the error using the material removal device, and
in response to a determination that the error is not correctable, terminating fabrication of an object of the plurality of objects that includes the object portion while continuing fabrication of one or more remaining objects of the plurality of objects.

Example 24. A system comprising:
a first printer assembly comprising:
   a carrier film configured to support a first material, and
   a first energy source configured to output first energy to cure the first material;
a second printer assembly comprising:
   a nozzle configured to deposit a second material, and
   a second energy source configured to output second energy to cure the second material;
at least one sensor;
a material removal device;
a processor operably coupled to the first printer assembly, the second printer assembly, the at least one sensor, and the material removal device; and
a memory operably coupled to the processor and storing instructions that, when executed by the processor, cause the system to perform operations comprising:
   forming a first object portion from the first material using the first printer assembly;
   forming a second object portion from the second material using the second printer assembly;
   obtaining sensor data of the second object portion using the at least one sensor;
   determining whether an error is present in the second object portion based on the sensor data; and
   in response to a determination that the error is present in the second object portion, correcting the error by removing a region of the second object portion containing the error, using the material removal device.

Example 25. A method comprising:
forming an object portion from a curable material using an additive manufacturing process;
obtaining sensor data of the object portion;
determining whether an error is present in the object portion, based on the sensor data; and
in response to a determination that the error is present in the object portion, removing a region of the object portion containing the error.

Example 26. The method of Example 25, wherein the curable material comprises a polymerizable fluid, and the additive manufacturing process comprises a material jetting process.

Example 27. The method of Example 26, wherein forming the object portion comprises depositing one or more droplets of the polymerizable fluid onto a build platform or a previously formed object portion.

Example 28. The method of Example 26 or 27, wherein removing the region of the object portion comprises suctioning the polymerizable fluid of the region of the object portion.

Example 29. The method of any one of Examples 26 to 28, wherein removing the region of the object portion comprises bringing a charged component into proximity with the polymerizable fluid of the region of the object portion.

Example 30. The method of any one of Examples 26 to 29, further comprising curing the polymerizable fluid of a remaining region of the object portion, after removing the region of the object portion.

Example 31. The method of any one of Examples 26 to 30, further comprising reducing a viscosity of the polymerizable fluid by one or more of heating the polymerizable fluid or applying mechanical perturbations to the polymerizable fluid.

Example 32. The method of any one of Examples 26 to 31, further comprising forming a second object portion from a second curable material using a second additive manufacturing process.

Example 33. The method of Example 32, wherein the second curable material comprises a polymerizable resin, and the second additive manufacturing process comprises stereolithography or digital light processing.

Example 34. The method of Example 33, wherein the object portion is formed on or proximate to the second object portion.

Example 35. The method of any one of Examples 25 to 34, wherein the at least one sensor comprises an imaging device and the sensor data comprises image data generated by the imaging device.

Example 36. The method of Example 35, wherein the image data is obtained at a wavelength in which the object portion is selectively visible.

Example 37. The method of Example 35 or 36, wherein the image data shows the object portion and the second object portion, and the method further comprises differentiating between the object portion and the second object portion in the image data.

Example 38. The method of any one of Examples 25 to 37, wherein the at least one sensor is configured to measure one or more of a velocity, an acceleration, a force, or a torque of a movable component of the printer assembly.

Example 39. The method of any one of Examples 25 to 38, wherein the curable material comprises a polymerizable resin, and the additive manufacturing process comprises stereolithography or digital light processing.

Example 40. The method of Example 39, further comprising curing the polymerizable resin of the object portion, before determining whether the error is present in the object portion.

Example 41. The method of Example 40, wherein removing the region of the object portion comprises ablating cured polymerizable resin of the region of the object portion.

Example 42. The method of any one of Examples 25 to 41, wherein determining whether the error is present comprises:
receiving a digital representation of a target geometry of the object portion,
determining an actual geometry of the object portion, based on the sensor data, and
determining whether there is a discrepancy between the actual geometry and the target geometry.

Example 43. The method of any one of Examples 25 to 42, wherein the error comprises excess curable material in the object portion.

Example 44. The method of any one of Examples 25 to 43, wherein the region of the object portion is selectively removed.

Example 45. The method of any one of Examples 25 to 44, wherein the entire object portion is removed.

Example 46. The method of any one of Examples 25 to 45, further comprising: obtaining second sensor data of the object portion, and determining whether the error is still present in the object portion, based on the second sensor data.

Example 47. The method of Example 46, wherein the second sensor data comprises second image data.

Example 48. The method of any one of Examples 25 to 47, wherein the additive manufacturing process comprises fabricating a plurality of objects concurrently, and wherein the method further comprises:
determining whether the error is correctable,
in response to a determination that the error is correctable, removing the region of the object portion containing the error, and
in response to a determination that the error is not correctable, terminating fabrication of an object of the plurality of objects that includes the object portion while continuing fabrication of one or more remaining objects of the plurality of objects.

Example 49. The method of Example 48, wherein the plurality of objects are fabricated based on a digital representation of the plurality of objects, and wherein terminating the fabrication of the object comprises removing the object from the digital representation.

Example 50. A non-transitory computer-readable storage medium comprising instructions that, when executed by one or more processors of a computing system, cause the computing system to perform operations comprising:
generating instructions configured to cause a printer assembly to form an object portion from a curable material using an additive manufacturing process;
receiving sensor data of the object portion;
determining whether an error is present in the object portion, based on the sensor data; and
in response to a determination that the error is present in the object portion, generating instructions configured to cause a material removal device to remove a region of the object portion containing the error.

Example 51. A method comprising:
receiving a digital representation of a plurality of objects;
forming a first portion of each object of the plurality of objects based on the digital representation, using an additive manufacturing process;
obtaining sensor data of the first portion of each object;
determining whether an error is present in the first portion of an object of the plurality of objects, based on the sensor data;
in response to a determination that the error is present in the first portion of the object, modifying the digital representation to remove the object having the error; and
forming a second portion of each remaining object of the plurality of objects based on the modified digital representation, using the additive manufacturing process.

Example 52. The method of Example 51, wherein the additive manufacturing process comprises building up each object in a plurality of layers, and the digital representation comprises a plurality of images for each object, the plurality of images representing the respective plurality of layers for each object.

Example 53. The method of Example 51 or 52, wherein the error comprises one or more of the following: deposition of material at an incorrect location, failing to deposit material at a correct location, deposition of an incorrect amount of material, curing of material at an incorrect location, failing to cure material at a correct location, incorrect curing extent, changes in a geometry of a material after deposition, or changes in a geometry of a material after curing.

Example 54. The method of any one of Examples 51 to 53, wherein determining whether the error is present comprises:
identifying a target geometry of the first portion of each object, based on the digital representation,
determining an actual geometry of the first portion of each object, based on the sensor data, and
determining whether there are discrepancies between the actual geometry and the target geometry of the first portion of each object.

Example 55. The method of any one of Examples 51 to 54, further comprising:
in response to the determination that the error is present, determining whether the error is correctable, and
in response to a determination that the error is not correctable, modifying the digital representation to remove the object.

Example 56. The method of Example 55, wherein the error is determined to not be correctable if one or more attempts to correct the error have been unsuccessful.

Example 57. The method of Example 55 or 56, wherein the error is determined to not be correctable based on one or more characteristics of the error.

Example 58. The method of any one of Examples 51 to 58, wherein modifying the digital representation comprises:
identifying a boundary associated with the object in the digital representation, and
masking or deleting a portion of the digital representation within the boundary.

Example 59. The method of any one of Examples 51 to 58, wherein the digital representation comprises a plurality of pixels representing a geometry of each object, and modifying the digital representation comprises modifying the plurality of pixels representing the geometry of the object containing the error.

Example 60. The method of Example 59, wherein the plurality of pixels are modified by converting each pixel to a baseline value.

Example 61. The method of any one of Examples 51 to 60, wherein the additive manufacturing process uses a single curable material.

Example 62. The method of any one of Examples 51 to 60, wherein the additive manufacturing process uses two or more different curable materials.

Example 63. The method of any one of Examples 51 to 62, wherein the additive manufacturing process comprises a high temperature lithography process.

Example 64. The method of any one of Examples 51 to 63, wherein the additive manufacturing process comprises a material jetting process.

Example 65. The method of any one of Examples 51 to 64, wherein the sensor data comprises image data.

Example 66. A system comprising:
a printer assembly configured to perform an additive manufacturing process;
at least one sensor;
a processor operably coupled to the printer assembly and the at least one sensor; and
a memory operably coupled to the processor and storing instructions that, when executed by the processor, cause the system to perform operations comprising:
   receiving a digital representation of a plurality of objects;
   forming a first portion of each object of the plurality of objects based on the digital representation, using the printer assembly;
   obtaining sensor data of the first portion of each object from the at least one sensor;
   determining whether an error is present in the first portion of an object of the plurality of objects, based on the sensor data;
   in response to a determination that the error is present in the first portion of the object, modifying the digital representation to remove the object having the error; and
   forming a second portion of each remaining object of the plurality of objects based on the modified digital representation, using the printer assembly.

Example 67. The system of Example 66, wherein the additive manufacturing process comprises building up each object in a plurality of layers, and the digital representation comprises a plurality of images for each object, the plurality of images representing the respective plurality of layers for each object.

Example 68. The system of Example 66 or 67, wherein the error comprises one or more of the following: deposition of material at an incorrect location, failing to deposit material at a correct location, deposition of an incorrect amount of material, curing of material at an incorrect location, failing to cure material at a correct location, incorrect curing extent, changes in a geometry of a material after deposition, or changes in a geometry of a material after curing.

Example 69. The system of any one of Examples 66 to 68, wherein determining whether the error is present comprises:
identifying a target geometry of the first portion of each object, based on the digital representation,
determining an actual geometry of the first portion of each object, based on the sensor data, and
determining whether there is a discrepancy between the actual geometry and the target geometry of the first portion of each object.

Example 70. The system of any one of Examples 66 to 69, further comprising:
in response to the determination that the error is present, determining whether the error is correctable, and
in response to a determination that the error is not correctable, modifying the digital representation to remove the object.

Example 71. The system of Example 70, wherein the error is determined to not be correctable if one or more attempts to correct the error have been unsuccessful.

Example 72. The system of Example 70 or 71, wherein the error is determined to not be correctable based on one or more characteristics of the error.

Example 73. The system of any one of Examples 66 to 72, wherein modifying the digital representation comprises:
identifying a boundary associated with the object in the digital representation, and
masking or deleting a portion of the digital representation within the boundary.

Example 74. The system of any one of Examples 66 to 73, wherein the digital representation comprises a plurality of pixels representing a geometry of each object, and modifying the digital representation comprises modifying the plurality of pixels representing the geometry of the object containing the error.

Example 75. The system of Example 74, wherein the plurality of pixels are modified by converting each pixel to a baseline value.

Example 76. The system of any one of Examples 66 to 75, wherein the additive manufacturing process uses a single curable material.

Example 77. The system of any one of Examples 66 to 75, wherein the additive manufacturing process uses two or more different curable materials.

Example 78. The system of any one of Examples 66 to 77, wherein the printer assembly comprises:
a carrier film configured to support a polymerizable resin, and
an energy source configured to output energy to selectively cure the polymerizable resin.

Example 79. The system of any one of Examples 66 to 78, wherein the printer assembly comprises:
a nozzle configured to deposit a polymerizable fluid, and
an energy source configured to output energy to cure the polymerizable fluid.

Example 80. The system of any one of Examples 66 to 79, wherein the at least one sensor comprises an imaging device and the sensor data comprises image data generated by the imaging device.

Example 81. A non-transitory computer-readable storage medium comprising instructions that, when executed by one or more processors of a computing system, cause the computing system to perform operations comprising:
receiving a digital representation of a plurality of objects;
instructing a printer assembly to form a first portion of each object of the plurality of objects based on the digital representation;
receiving sensor data of the first portion of each object;
determining whether an error is present in the first portion of an object of the plurality of objects, based on the sensor data;
in response to a determination that the error is present in the first portion of the object, modifying the digital representation to remove the object having the error; and
instructing the printer assembly to form a second portion of each remaining object of the plurality of objects based on the modified digital representation.

Example 82. A system comprising:
a printer assembly configured to perform an additive manufacturing process;
at least one sensor;
a processor operably coupled to the printer assembly and the at least one sensor; and
a memory operably coupled to the processor and storing instructions that, when executed by the processor, cause the system to perform operations comprising:
   receiving a digital representation of a plurality of objects;
   forming a portion of each object of the plurality of objects based on the digital representation, using the printer assembly;
   obtaining sensor data of the portion of each object from the at least one sensor;
   determining whether an error is present in the portion of an object of the plurality of objects, based on the sensor data; and
   in response to a determination that the error is present in the portion of the object, performing an error correction process.

Example 83. The system of Example 82, wherein the error correction process comprises modifying the digital representation.

Example 84. The system of Example 83, wherein the digital representation is modified to remove the object having the error, and the operations further comprise forming a subsequent portion of each remaining object of the plurality of objects based on the modified digital representation, using the printer assembly.

Example 85. The system of Example 84, wherein the object having the error is removed by masking or deleting a portion of the digital representation corresponding to the object.

Example 86. The system of Example 84 or 85, wherein the object having the error is removed in response to a determination that the error is not correctable.

Example 87. The system of Example 83, wherein the digital representation is modified by one or more of the following: changing a geometry of the portion of the object, changing an energy parameter of the portion of the object, changing a geometry of a subsequent portion of the object, changing an energy parameter of a subsequent portion of the object, changing a geometry of the portion of another object, changing an energy parameter of the portion of another object, changing a geometry of a subsequent portion of another object, or changing an energy parameter of a subsequent portion of another object.

Example 88. The system of Example 86, wherein the operations further comprise forming a portion of each object of the plurality of objects based on the modified digital representation, using the printer assembly.

Example 89. The system of any one of Examples 83 to 87, wherein the error correction process comprises removing a region of the portion of the object containing the error using a material removal device.

Example 90. The system of any one of Examples 83 to 89, wherein the printer assembly is configured to form the plurality of objects from a single material.

Example 91. The system of any one of Examples 83 to 89, wherein the printer assembly is configured to form the plurality of objects from a plurality of different materials.

Example 92. The system of any one of Examples 83 to 91, wherein the additive manufacturing process comprises one or more of stereolithography, digital light processing, or material jetting.

Example 93. The system of any one of Examples 83 to 92, wherein the at least one sensor comprises an imaging device and the sensor data comprises image data generated by the imaging device.

Example 94. The system of any one of Examples 83 to 93, wherein the at least one sensor is configured to measure one or more of a velocity, an acceleration, a force, or a torque of a movable component of the printer assembly.

Example 95. A method comprising:
receiving a digital representation of a plurality of objects;
forming a portion of each object of the plurality of objects based on the digital representation, using an additive manufacturing process;
obtaining sensor data of the portion of each object;
determining whether an error is present in the portion of an object of the plurality of objects, based on the sensor data; and
in response to a determination that the error is present in the portion of the object, performing an error correction process.

Example 96. The method of Example 95, wherein the error correction process comprises modifying the digital representation.

Example 97. The method of Example 96, wherein the digital representation is modified to remove the object having the error, and the method further comprise forming a subsequent portion of each remaining object of the plurality of objects based on the modified digital representation, using the additive manufacturing process.

Example 98. The method of Example 97, wherein the object having the error is removed by masking or deleting a portion of the digital representation corresponding to the object.

Example 99. The method of Example 97 or 98, wherein the object having the error is removed in response to a determination that the error is not correctable.

Example 100. The method of Example 96, wherein the digital representation is modified by one or more of the following: changing a geometry of the portion of the object, changing an energy parameter of the portion of the object, changing a geometry of a subsequent portion of the object, changing an energy parameter of a subsequent portion of the object, changing a geometry of the portion of another object, changing an energy parameter of the portion of another object, changing a geometry of a subsequent portion of another object, or changing an energy parameter of a subsequent portion of another object.

Example 101. The method of Example 100, further comprising forming a portion of each object of the plurality of objects based on the modified digital representation, using the additive manufacturing process.

Example 102. The method of any one of Examples 95 to 101, wherein the error correction process comprises removing a region of the portion of the object containing the error.

Example 103. The method of any one of Examples 95 to 102, wherein the additive manufacturing process comprises forming the plurality of objects from a single material.

Example 104. The method of any one of Examples 95 to 102, wherein the additive manufacturing process comprises forming the plurality of objects from a plurality of different materials.

Example 105. The method of any one of Examples 95 to 104, wherein the additive manufacturing process comprises one or more of stereolithography, digital light processing, or material jetting.

Example 106. The method of any one of Examples 95 to 106, wherein the sensor data comprises image data.

Example 107. The method of any one of Examples 95 to 106, wherein the sensor data is indicative one or more of a velocity, an acceleration, a force, or a torque of a movable component of a printer assembly configured to perform the additive manufacturing process.

### CONCLUSION

Although many of the embodiments are described above with respect to systems, devices, and methods for manufacturing dental appliances, the technology is applicable to other applications and/or other approaches, such as manufacturing of other types of objects. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1A-13.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A method comprising:
receiving a digital representation of a plurality of objects;
forming a first portion of each object of the plurality of objects based on the digital representation, using an additive manufacturing process;
obtaining sensor data of the first portion of each object;
determining whether an error is present in the first portion of an object of the plurality of objects, based on the sensor data;
in response to a determination that the error is present in the first portion of the object, modifying the digital representation to remove the object having the error; and
forming a second portion of each remaining object of the plurality of objects based on the modified digital representation, using the additive manufacturing process.

2. The method of claim 1, wherein the additive manufacturing process comprises building up each object in a plurality of layers, and the digital representation comprises a plurality of images for each object, the plurality of images representing the respective plurality of layers for each object.

3. The method of claim 1, wherein the error comprises one or more of the following: deposition of material at an incorrect location, failing to deposit material at a correct location, deposition of an incorrect amount of material, curing of material at an incorrect location, failing to cure material at a correct location, incorrect curing extent, changes in a geometry of a material after deposition, or changes in a geometry of a material after curing.

4. The method of claim 1, wherein determining whether the error is present comprises:
identifying a target geometry of the first portion of each object, based on the digital representation,
determining an actual geometry of the first portion of each object, based on the sensor data, and
determining whether there are discrepancies between the actual geometry and the target geometry of the first portion of each object.

5. The method of claim 1, further comprising:
in response to the determination that the error is present, determining whether the error is correctable, and
in response to a determination that the error is not correctable, modifying the digital representation to remove the object.

6. The method of claim 1, wherein modifying the digital representation comprises:
identifying a boundary associated with the object in the digital representation, and masking or deleting a portion of the digital representation within the boundary.

7. The method of claim 1, wherein the digital representation comprises a plurality of pixels representing a geometry of each object, and modifying the digital representation comprises modifying the plurality of pixels representing the geometry of the object containing the error.

8. The method of claim 7, wherein the plurality of pixels are modified by converting each pixel to a baseline value.

9. The method of claim 1, wherein the additive manufacturing process uses a single curable material.

10. The method of claim 1, wherein the additive manufacturing process uses two or more different curable materials.

11. The method of claim 1, wherein the additive manufacturing process comprises a high temperature lithography process.

12. The method of claim 1, wherein the additive manufacturing process comprises a material jetting process.

13. The method of claim 1, wherein the sensor data comprises image data.

14. A method comprising:
receiving a digital representation of a plurality of objects;
forming a portion of each object of the plurality of objects based on the digital representation, using an additive manufacturing process;
obtaining sensor data of the portion of each object;
determining whether an error is present in the portion of an object of the plurality of objects, based on the sensor data; and
in response to a determination that the error is present in the portion of the object, performing an error correction process, wherein the error correction process comprises modifying the digital representation.

15. The method of claim 14, wherein the digital representation is modified to remove the object having the error, and the method further comprise forming a subsequent portion of each remaining object of the plurality of objects based on the modified digital representation, using the additive manufacturing process.

16. The method of claim 15, wherein the object having the error is removed by masking or deleting a portion of the digital representation corresponding to the object.

17. The method of claim 15, wherein the object having the error is removed in response to a determination that the error is not correctable.

18. The method of claim 14, wherein the digital representation is modified by one or more of the following: changing a geometry of the portion of the object, changing an energy parameter of the portion of the object, changing a geometry of a subsequent portion of the object, changing an energy parameter of a subsequent portion of the object, changing a geometry of the portion of another object, changing an energy parameter of the portion of another object, changing a geometry of a subsequent portion of another object, or changing an energy parameter of a subsequent portion of another object.

19. The method of claim 18, further comprising forming a portion of each object of the plurality of objects based on the modified digital representation, using the additive manufacturing process.

20. The method of claim 14, wherein the error correction process comprises removing a region of the portion of the object containing the error.
